(19) United States
(12) Patent Application Publication
(10) Pub. No.: US 2003/0064909 A1
(43) Pub. Date: Apr. 3, 2003

(54) Laundry detergent and/or fabric care compositions comprising a transferase

(75) Inventors: Mary Vjayarani Barnabas, West Chester, OH (US); Andre Cesar Baeck, Bonheiden (BE); Michael Stanford Showell, Cincinnati, OH (US); Johan Smets, Lubbeek (BE); Andre Christian Convents, Cincinnati, OH (US); Bruno Albert Jean Hubesch, Neerijse (BE); Christian Leo Marie Vermote, Destelbergen (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 10/166,906

(22) Filed: Jun. 11, 2002

Related U.S. Application Data
(63) Continuation of application No. 09/674,230, filed on Oct. 27, 2000, now abandoned.
Application No. 09/674,230 is a 371 of international application No. PCT/US98/08629, filed on Apr. 29, 1998.

(51) Int. Cl. C11D 3/00

(52) U.S. Cl. 510/392

(57) ABSTRACT

The present invention relates to laundry detergent and/or fabric care compositions comprising a transferase, preferably an alkaline transferase, wherein when said transferase is a xyloglucan transferase, said xyloglucan transferase exhibits greater transferase activity than hydrolytic activity and/or exhibits higher reaction rates for donor substrates with higher molecular weight than for donor substrates with lower molecular weight.

### RELATED APPLICATIONS

This application is a continuation of U.S. application Ser. No. 09/674,230 filed Oct. 27, 2000, which is a 371 application of International Application No. PCT/US98/08629 filed Apr. 29, 1998.

### FIELD OF THE INVENTION

The present invention relates to laundry detergent and/or fabric care compositions comprising a transferase.

### BACKGROUND OF THE INVENTION

Laundry detergent and/or fabric care compositions are well-known in the art and extensively represented in the market place.

Laundry detergent compositions include nowadays a complex combination of active ingredients which fulfil certain specific needs:a surfactant system, enzymes providing cleaning and fabric care benefits, bleaching agents, a builder system, suds suppressors, soil-suspending agents, soil-release agents, optical brighteners, softening agents, dispersants, dye transfer inhibition compounds, abrasives, bactericides, perfumes, and their overall performance has indeed improved over the years.

However, the complex nature of everyday “body” soils typically found on pillow cases, T-shirts, collars and socks, provides a continuous thorough cleaning challenge for detergents. These soils are difficult to remove completely and often residues build up on fabric leading to dinginess and yellowing. In addition, removal by detergents of stains stemming from plants, wood, mud-clay based soil and fruits is one of the toughest cleaning challenges, in particular with the tendency to move to low wash temperatures and shorter washing cycles. These stains typically contain complex mixtures of fibrous material, based mainly on carbohydrates and their derivatives, fibre and cell wall components. Such stains are generally accompanied by amylose, sugars and their derivatives.

In recent years, consumer desirability for fabric conditioning compositions has risen. Fabric softening compositions impart several desirable properties to treated garments including softness and static control. Fabric softness of laundered garments is typically achieved by delivering a quaternary ammonium compound to the surface of the fabric.

Consumer desirability for durable press fabric garments, particularly cotton fabric garments, has also risen. Durable press garments include those garments which resist wrinkling of the fabric both during wear and during the laundering process. Durable press garments can greatly decrease the hand work associated with laundering by eliminating ironing or reducing ironing time sometimes necessary to prevent wrinkling of the garment. However, in most commercially available durable press fabrics, the fabric's ability to resist wrinkling is reduced over time as the garment is repeatedly worn and laundered.

Furthermore, coloured garments have a tendency to wear and show appearance losses. A portion of this colour loss may be attributed to abrasion in the laundering process, particularly in automatic washing machines and automatic laundry dryers.

Moreover, tensile strength loss of fabric appears as an unavoidable result of mechanical/chemical action due to use/wearing or washing.

As indicated above, there is a continuous need for a laundry detergent composition which provides excellent fabric cleaning and/or fabric stain removal, especially on body soils and plant based stains and/or fabric whiteness maintenance and/or fabric color appearance and/or dye transfer inhibition.

In addition, there is a continuous need for a laundry detergent composition and/or fabric care composition, which can provide, refurbish or restore tensile strength, anti-wrinkle, anti-bobbling and anti-shrinkage properties to fabrics, as well as provide static control, fabric softness, colour appearance and fabric anti-wear properties and benefits.

The above objectives have been met by formulating laundry detergent and/or fabric care compositions comprising a transferase.

It is a further object of the present invention to provide detergent composition and/or fabric care composition comprising transferase enzyme, which can provide, refurbish or restore improved tensile strength, enhanced anti-wrinkle, anti-bobbling and anti-shrinkage properties to fabrics, as well as provide better static control, fabric softness, colour appearance and fabric anti-wear properties and benefits, while providing improved cleaning benefits.

The above objective has been met by formulating laundry detergent and/or fabric care compositions further comprising a surfactant selected from nonionic and/or anionic and/or cationic and/or mixtures thereof, a detergent enzyme, a bleaching agent, a dye transfer inhibiting polymer, a dispersant and/or a smectite clay.

Transferase enzymes have been described in the art:

A process for producing saccharides of a definite chain length such as maltose and maltooligosaccharides in an isolated and highly pure form using a saccharide chain transferase such as cyclodextrin glycosyltransferase or a-amylase, has been disclosed in EP 560 982. These so-produced saccharides are used in the pharmaceutical field.

U.S. Pat. No. 5,516,689 describes an enzyme composition and a means of reducing the stickiness of honeydew contaminated cotton. Transglucosidases and/or pectinases are used to hydrolyse and/or reduce honeydew on cotton fiber for reducing the stickiness of such fiber and avoid severe problems during the milling of cotton.

Microbial transglutaminases, their production and their use in a variety of industrial purposes, including gelling of proteins, improvement of baking quality of flour, producing paste type food material from protein, fat and water, preparation of cheese from milk concentrate, binding of chopped meat, improvement of taste and texture of food proteins, casein finishing in leather processing, shoe shine, etc. have been described in WO96/0693 1.

JP 7-107971 relates to a micro-organism belonging to the genus Bacillus and having the capacity to produce an alkali resistant cyclodextrin glucanotransferase. Said enzyme can be used in dishwashing applications wherein it demonstrates decomposition and removal of food soils and the produced cyclodextrin plays as a masking, de-odorizing agent. Moreover said alkali resistant cyclodextrin glucanotransferase improves the cleaning capabilities of said compositions by improving the sudsing properties and stimulating the emulsification of the soiling.

Dishwashing detergent compositions containing cyclodextrin glucanotransferase with cleaning benefits and deodorising effect are described in JP 7-109488.

WO 97/23683 relates to the use of xyloglucan endotransglycosylase (XET) to provide strength and/or shape-retention and/or anti-wrinkling properties to cellulosic material.

Nevertheless, none of these documents teaches the cleaning or fabric care benefits obtained by transferase enzymatic activity from transferases nor xyloglucan transferases that exhibit greater transferase activity than hydrolytic activity and/or xyloglucan transferases that exhibit higher reaction rates for donor substrates with higher molecular weight than for donor substrates with lower molecular weight, when used in the laundry and/or fabric care process.

### SUMMARY OF THE INVENTION

The present invention relates to laundry detergent and/or fabric care compositions comprising a transferase for fabric care and/or cleaning benefits.

### DETAILED DESCRIPTION OF THE INVENTION

The Transferase Enzymes and their Substrates

An essential component of the laundry detergent and/or fabric care compositions of the present invention is a transferase enzyme.

Transferase enzymes catalyse the transfer of functional compounds to a range of substrates. Particularly, the transferase of the invention have the potential to transfer a chemical moiety, for example a methyl group or a glycosyl group, from a small substrate to form oligomeric molecules or elongate polymeric compounds. Using small substrates, the enzyme improves the properties of garments by binding functional groups like methyl, hydroxymethyl, formyl, carboxyl, aldehyde, ketone, acyl, amino and phosphorous functional groups and/or transferring glycosyl residues to the garment surface. The improved garments properties include tensile strength, anti-wrinkle, anti-bobbling and anti-shrinkage properties to fabrics, static control, fabric softness, colour appearance and fabric anti-wear properties and benefits. When the transferase level is high and the substrate concentration is low, the functional groups are transferred to water molecules providing cleaning benefits.

Suitable transferases for the present invention are represented by the EC 2.1 Transferring one-carbon groups enzymes, EC 2.2 Transferring aldehyde or ketone residues enzymes, EC 2.3 Acyltransferases, EC 2.4 Glycosyltransferase, EC 2.5 Transferring alkyl or aryl groups other than methyl groups enzymes, EC 2.6 Transferring nitrogenous groups enzymes and EC 2.7 Transferring phosphorus-containing groups enzymes.

Examples of suitable transferases are:

EC 2.1.1.15 Fatty acid O-methyltransferase

EC 2.1.1.18 Polysaccharide O-methyltransferase

EC 2.1.2.1 Glycine hydroxymethyltransferase

EC 2.1.2.4 Glycine formiminotransferase

EC 2.2.1.3 Formaldehyde transketolase

EC 2.3.1.3 Glucosamine N-acetyltransferase

EC 2.3.1.18 Galactoside acetyl transferase

EC 2.3.1.57 Diamine N-acetyltransferase

EC 2.3.1.75 Long-chain-alcohol O-fatty-acyltransferase

EC 2.3.1.79 Maltose O-acetyltransferase

EC 2.3.1.84 Alcohol O-fatty acetyltransferase

EC 2.3.1.88 Peptide a-N-acetyltransferase

EC 2.3.1.96 Glycoprotein N-palmitoyltransferase

EC 2.3.1.142 Glycoprotein O-fatty-acyltransferase

EC 2.5.1.10 Geranyltranstransferase

EC 2.5.1.20 Rubber cis-polypremylcistransferase

EC 2.6.1 Aminotransferase

For specific applications, preferred transferases demonstrate some/most of their activity in the alkaline conditions, i.e., enzymes having an enzymatic activity of at least 10%, preferably at least 25%, more preferably at least 40% of its maximum activity at a pH ranging from 7 to 12. More preferred transferases are enzymes having their maximum activity at a pH ranging from 7 to 12. Other preferred transferase is a transferase having at least 50% of its maximum activity between 10° C. and 50° C.

Preferred transferases for the laundry detergent and/or fabric care compositions of the present invention are included in the acyltransferases (EC 2.3) and glycosyltransferases classes (EC 2.4).

Of particular interest is the group of acyltransferases, especially the aminoacyl transferases (EC 2.3.2). These are enzymes transferring amino groups from a donor, generally an amino acid, to an acceptor. Even more preferred is the protein-glutamine y-glutamyltransferase (EC 2.3.2.13), also available under the name transglutaminase. Without wishing to be bound by theory, it is believed that enzymatic crosslinking of amino acids, di/tri/poly-peptides and/or proteins will occur on the fabric, resulting in increased tensile strength and improved appearance. Moreover, hydrolysis by an aminoacyl transferase of said substrates present in the soils/stains, will provide cleaning benefits.

Of particular interest is also the group of glycosyltransferases. The general properties of these enzymes is to transfer a sugar from oligosaccharides to another carbohydrate as acceptor. Both hexosyltransferases and pentosyltransferases can be used in the invention. Glycosyltransferases catalyse both hydrolytic and transfer reactions in incubation with oligosaccharides. As a result of the enzymatic activity, oligosaccharides are converted into a new class of polysaccharides. It has been surprisingly found that glycosyltransferases improve the tensile strength and appearance of fabrics, e.g. reduce fabric wrinkles. Without wishing to be limited by any theory, it is indeed believed that due to the glycosyltransferase activity, oligosaccharides are bound to the cellulose polymers of cotton fabrics resulting in improved tensile strength and demonstrating appearance benefits especially after multiple wash cycles.

Without wishing to be bound by theory, the glycosyltransferase activity is believed to have four potential modes of action providing fabric care benefits:

Enzymatic stitching wherein the enzyme is thought to bind oligosaccharides to cellulose fibers with reduced tensile strength;

Enzymatic cross-linking wherein the glycosyltransferase is thought to bind cellulose fibers with reduced tensile strength together; and

Enzymatic polymer linking wherein polymers are linked to cellulose fibers with reduced tensile strength.

In addition, in presence of a low level of substrate and a high level of glycosyltransferase, the glycosyl groups are transferred to water molecules providing cleaning benefits.

For example, transglucosidase is an enzyme that catalyses both hydrolytic and transfer reactions in solutions containing α-D-gluco-oligosaccharides. As a result of the transglucosidase enzymatic reactions, the malto-oligosaccharides are converted to isomalto-oligosaccharides providing a new class of polysaccharides characterised by a higher proportion of saccharides linked by α-D-1,6 linkages from the non-reducing end.

These transglucosidase reactions have been found to provide fabric care performance. It is believed that the improved tensile strength, the reduced wrinkling and better appearance are due to oligosaccharides bound to the cellulose polymers fibers of cotton.

Examples of suitable glycosyltransferases are galactosyl transferases and fiuctosyltransferases, such as 1,4-β-galactosyltransferase; 1,3-α-fiuctosyltransferase; 2,3-sialyl transferase; cyclodextrin glycosyltransferase; N-acetylgluco- or -galactosaminyltransferase; and

| | |
|---|---|
| EC 2.4.1.2 | 1,4-α-D-glucan:1,6-α-D-glucan 6-α-D-glucosyltransferase |
| EC 2.4.1.4 | Sucrose:1,4-α-D-glucan 4-α-D-glucosyltransferase |
| EC 2.4.1.5 | Sucrose:1,6-α-D-glucan 6-α-D-glucosyltransferase |
| EC 2.4.1.9 | Sucrose:2,1-β-D-fructan 1-β-D-fructosyltransferase |
| EC 2.4.1.10 | Sucrose:2,6-β-D-fructan 6-β-D-fructosyltransferase |
| EC 2.4.1.11 | UDPglucose:glycogen 4-α-D-glucosyltransferase |
| EC 2.4.1.12 | UDPglucose:1,4-β-D-glucan 4-β-D-glucosyltransferase |
| EC 2.4.1.13 | UDPglucose:D-fructose 2-α-D-glucosyltransferase |
| EC 2.4.1.16 | UDP-N-acetylglucosamine:chitin 4-β-N-acetylglucos- |
| | aminyltransferase |
| EC 2.4.1.18 | 1,4-α-D-glucan:1,4-α-D-glucan 6-α-D-(1,4-α-D-glucano)- |
| | transferase |
| EC 2.4.1.19 | 1,4-α-D-glucan 4-α-D-(1,4-α-D-glucano)-transferase |
| | (cyclizing) |
| EC 2.4.1.21 | ADPglucose:1,4-α-D-glucan 4-α-Dglucosyltransferase |
| EC 2.4.1.24 | 1,4-α-D-glucan:1,4-α-D-glucan(D-glucose) 6-α-D- |
| | glucosyltransferase |
| EC 2.4.1.25 | 1,4-α-D-glucan:1,4-α-D-glucan 4-α-D-glycosyltransferase |
| EC 2.4.1.29 | GDPglucose:1,4-β-D-glucan 4-β-D-glucosyltransferase |
| EC 2.4.1.34 | 1,3-β-glucan synthetase |
| EC 2.4.1.35 | UDPglucose:phenol β-D-glucosyltransferase |
| EC 2.4.1.49 | 1,4-β-D-oligo-D-glucan:orthophosphate α-d-glucosyl- |
| | transferase |
| EC 2.4.1.67 | 1-α-D-galactosyl-myo-inositol:raffinosegalactosyl- |
| | transferase |
| EC 2.4.1.71 | UPDglucose:arylamine N-D-glucosyltransferase |
| EC 2.4.1.75 | UDPgalacturonate β-D-galacturonosyltransferase |
| EC 2.4.1.82 | 1-α-D-galactosyl-myo-inositol:sucrose 6-α-D-galactosyl- |
| | transferase |
| EC 2.4.1.90 | UDPgalactose:N-acetyl-D-glucosamine 4-β-galactosyl- |
| | transferase |
| EC 2.4.1.93 | Inulin D-fructosyl-D-fructosyltransferase |
| EC 2.4.1.99 | Sucrose:1F-fructosyltransferase |
| EC 2.4.1.100 | 1,2-β-D-fructan:1,2-β-D-fructan 1-β-D-fructosyltransferase |
| EC 2.4.1.113 | ADPglucose:protein 4-α-D-glucosyltransferase |
| EC 2.4.1.121 | UDPglucose:indole-3-acetate β-D-glucosyltransferase |
| EC 2.4.1.125 | Sucrose:1,6-α-D-glucan 3(6)-α-D-glucosyltransferase |
| EC 2.4.1.140 | Sucrose:1,6(1,3)-α-D-glucan 6(3)-α-D-glucosyltransferase |
| EC 2.4.1.161 | 1,4-α-D-glucan:1,4-α-D-glucan 4-α-D-glucosyltransferase |
| EC 2.4.1.168 | UDPglucose:xyloglucan 1,4-β-D-glucosyltransferase |
| EC 2.4.1.169 | UDP-D-xylose:xyloglucan 1,6-β-D-xylosyltransferase |
| EC 2.4.1.183 | UDPglucose:α-D-(1,3)-glucan 3-α-D-glucosyltransferase |

Of particular interest is EC 2.4.1.24 1,4-α-D-glucan: 1,4-a-D-glucan(D-glucose) 6-α-D-glucosyl transferase. A particulate member of this enzyme is commercially available under the name Transglucosidase L-500.

In addition to the glycosyltransferases discussed above, it has been found that mutant glycosyltransferases and/or mutant glycosidases, examples of which are described in PCT Application Publication No. WO 97/21822, its Canadian equivalent Canadian Patent No. 2,165,041, and its U.S. equivalent U.S. Pat. No. 5,716,812, all to S. G. Withers et al., improve the tensile strength and appearance of fabrics, e.g., reduce fabric wrinkles, enhance shape retention and reduce shrinkage. The mutant forms of glycosyltransferases and/or glycosidases provide enzymatic stitching, enzymatic cross-linking and enzymatic polymer linking, as discussed above in greater detail.

The mutant glycosyltransferases and/or mutant glycosidases only have one nucleophilic amino acid on the active site of the enzyme, rather than two, like non-mutated glycosyltransferases and/or non-mutated glycosidases, respectively. In other words, the mutant glycosyltransferases and/or mutant glycosidases are formed in which one of the normal nucleophilic amino acids within the active site has been changed to a non-nucleophilic amino acid. As a result, the mutant glycosyltransferases and/or mutant glycosidases only exhibit transferase activity; no hydrolytic activity is exhibited by the mutant glycosyltransferases nor the mutant glycosidases. Accordingly, unlike non-mutated glycosyltransferases and/or non-mutated glycosidases, the mutant glycosyltransferases and/or mutant glycosidases convert oligosaccharides into a new class of polysaccharides without the detrimental hydrolyzation of the new class of polysaccharides back into oligosaccharides or without water acting as acceptor for the transfer reaction.

These mutant glycosyltransferases and/or mutant glycosidases can be extracted from plant, yeast, bacteria or other organisms. The DNA of the mutant glycosyltransferases and/or mutant glycosidases can be cloned and expressed in bacteria, yeast or fungi and obtained in this way.

These mutant glycosyltransferases and/or mutant glycosidases can be incorporated into heavy duty liquid detergents, heavy duty granular detergents, fabric care compositions, and the like.

In addition to the usefulness of mutant glycosyltransferases and/or mutant glycosidases in laundry detergents and fabric care compositions, they can also be used in solutions for the treatment of fabrics in the textile process industry, and the treatment of paper and paper pulp.

The novel characteristics and properties of the mutated glycosyltransferases and/or the mutated glycosidases make them highly suitable for use in laundry detergent and fabric care compositions because the absence of hydrolytic activity implies no loss in tensile strength of fabrics, even in the absence of donors in the transferase reaction.

When mutant glycosyltransferases and/or mutant glycosidases are present in the compositions of the present invention, it is desirable that the saccharide concentration in the compositions is in the range of from about 0.01% to 30% by weight of the total composition, more preferably, 1% to 10% by weight of the total composition. Furthermore, the compositions of the present invention can have saccharides of high molecular weight added to the compositions to obtain the benefits discussed above.

Another class of enzymes that is of particular interest is xyloglucan transferases. A preferred xyloglucan transferase is endoxyloglucan transferase (“EXT”), which is described in J. Plant Res. 108, 137-148, 1995 by Nishitani, Kagoma University, and now called “EXGT” in Int. Review of Cytology, Vol. 173, p. 157, 1997 by Nishitani, Kagoma University. EXT is also described in J. Biol. Chem. 267, 21058-21064, 1992 by Nishitani et al.

Like the mutant glycosyltransferases discussed above, this endoxyloglucan transferase improves the tensile strength and appearance of fabrics, e.g., reduce fabric wrinkles, enhance shape retention and reduce shrinkage. The endoxyloglucan transferase stitch cellulose fibrils. These stitching properties of the enzyme on cellulose fibrils delivers the above mentioned benefits.

Endoxyloglucan transferase is responsible for rejoining intermicrofibrillar xyloglucan chains, the xyloglucan chains between cellulosic microfibrils during the formation of plant cell walls. By rejoining the cellulosic microfibrils through xyloglucan linkages, the cellulose structure acquires improved strength of the fibers. Since the structure of fabrics is of cellulosic nature, the enzyme has a stitching activity on the microfibrils. Also shape retention, anti-shrinkage and anti-wrinkle benefits can be explained by the stitching properties of the enzyme.

Endoxyloglucan transferase differs in activity from xyloglucan endotransglycosylase (“XET transferase”), which is described in WO 97/23683 to Novo Nordisk A/S, in Biochem. J. (1992) 282, 821-828 by Fry et al. and in Plant J. (1993) 3(5), 691-700. The difference being that the xyloglucan endotransglycosylase shows both transferase activity and hydrolase (“hydrolytic”) activity. In contrast, endoxyloglucan transferase only shows transferase activity. No hydrolase activity is shown by endoxyloglucan transferase. Accordingly, unlike xyloglucan endotransglycosylase, the endoxyloglucan transferase converts oligosaccharides into a new class of polysaccharides without the detrimental hydrolyzation of the new class of polysaccharides back into oligosaccharides.

Furthermore, the endoxyloglucan transferase exhibits strict donor specificity for high molecular weight xyloglucan polymers and does not act on lower molecular weight xyloglucan oligomers. Preferably, endoxyloglucan transferase exhibits strict donor specificity for xyloglucan polymers having molecular weights of at least 10,000.

The novel characteristics and properties of endoxyloglucan transferase make it highly suitable for use in laundry detergent and fabric care compositions because the absence of hydrolytic activity implies no loss in tensile strength of fabrics, even in the absence of donors in the transferase reaction. Furthermore, lower levels of substrate donor can be used. Without desiring to be limited, it is believed that high benefits can be obtained even in the absence of a donor substrate if the endoxyloglucan transferase uses xyloglucans of the primary wall of the cotton fiber within fabrics.

Endoxyloglucan transferase can be extracted from plants and other organisms. Endoxyloglucan transferase can be obtained from a large number of plants including, but not limited to, A. thaliana and V. angularis. Alternatively, the DNA of the enzyme can be cloned and expressed in bacteria, yeast or fungi and obtained in this way.

The endoxyloglucan transferase can be incorporated into heavy duty liquid detergents, heavy duty granular detergents, fabric care compositions, and the like.

In addition to its usefulness in laundry detergent and fabric care compositions, endoxyloglucan transferase can also be used in solutions for the treatment of fabrics in the textile process industry, and for the treatment of paper and paper pulp.

When endoxyloglucan transferase is present in the compositions of the present invention, it is desirable that the xyloglucan concentration in the compositions is in the range of from about 0.01% to 30% by weight of the total composition, more preferably, 1% to 10% by weight of the total composition. Furthermore, the compositions of the present invention can have xyloglucan polymers of high molecular weight added to the compositions to obtain the benefits discussed above.

Accordingly, when the transferase is a xyloglucan transferase, such as endoxyloglucan transferase, the xyloglucan transferase preferably exhibits greater transferase activity than hydrolase (hydrolytic) activity and/or the xyloglucan transferase preferably exhibits strict donor specificity for high molecular weight xyloglucan polymers and does not act on lower molecular weight xyloglucan oligomers, more preferably the xyloglucan transferase exhibits strict donor specificity for xyloglucan polymers having molecular weights of at least 10,000.

Yet another enzyme that is of particular interest is cyclomaltodextrin glucanotransferase (“CGT-ase”) (EC 2.4.1.19), which is commercially available from Amano and Novo Nordisk A/S.

Covalent linking of carbohydrates, oligo and polysaccharides to cotton surfaces, such as fabrics, with a transferase delivers benefits such as anti-wrinkling, color maintenance, dye fixation and soil repulsion. Covalent linkage of glucose units to the cellulose surface versus a physical absorption of polymers, which are produced by the transferase in situ (or others), make the observed benefits durable.

Cyclomaltodextrin glucanotransferase is a transferase that exhibits several different actions on starch. It produces from starch α, β, and γ cyclodextrins, hydrolyzes starch and cross links starch. In these types of reactions, α, sugars are both donor and acceptor for the transferase reaction. Up to now, it was not clear if these transferase enzymes could covalently link sugar units to cotton.

Surprisingly, it has been found that cyclomaltodextrin glucanotransferase can covalently link glucose units from α-cyclodextrine to the cotton surfaces of fabrics at the non-reducing end of the cellulose polymers. Accordingly, cyclomaltodextrin glucanotransferase has the ability to make the benefits discussed above more durable.

As discussed above, it is known that covalently linking cellulose polymers with cross-linking agents delivers benefits to fabrics, such as anti-wrinkle benefits, but anti-wrinkle benefits can also be obtained by a physical absorption of polymers on the cotton surface. This physical absorption of polymers on the cotton surface can now be made more durable since one of the polymer units is covalently linked to the cotton surface by the action of cyclomaltodextrin glucanotransferase. Since these more durable benefits are produced enzymatically, the covalent linking occurs at a much lower temperature, thus, much lower temperatures as compared to conventional wash cycles are feasible in the wash cycle. In addition, conventional cross-linking chemicals (some of them are potentially toxic), which are used in the textile industry, are not applicable at the lower temperatures in the wash cycle.

Other benefits, such as dye fixation and improved soil release, are obtained through the covalent incorporation of cationic or anionic glucose units to the cotton surface.

Accordingly, the use of cyclomaltodextrin glucanotransferase in laundry detergent and fabric care compositions provides improved anti-wrinkle, shape retention, anti-shrinkage, dye fixation, soil repulsion and tensile strength benefits for fabrics.

The cyclomaltodextrin glucanotransferase can be incorporated into heavy duty liquid detergents, heavy duty granular detergents, fabric care compositions, and the like.

In addition to its usefulness in laundry detergent and fabric care compositions, cyclomaltodextrin glucanotransferase can also be used in solutions for the treatment of fabrics in the textile process industry, and for the treatment of paper and paper pulp.

When cyclomaltodextrin glucanotransferase is present in the compositions of the present invention, it is desirable that the starch concentration in the compositions is in the range of from about 0.01% to 30% by weight of the total composition, more preferably, 1% to 10% by weight of the total composition. Furthermore, the compositions of the present invention can have cyclodextrins or types of starch and sucrose added to the compositions to obtain the benefits discussed above.

Still yet another group of enzymes that is of particular interest is glucansucrases, of which dextransucrase (EC 2.4.1.5), a glycosyltransferase, is one example. Other glucansucrases that are suitable for use in the compositions described herein include, but are not limited to, various dextransucrases and alternansucrases. Alternatively, levansucrase, which is commercially available from Genencor, can be used.

Dextransucrase enzymes can be obtained from any suitable source known in the art, and are used in conjunction with appropriate substrates (sucrose +/− maltose). Dextransucrase catalyzes transfer reactions of glycosyl residues from one polysaccharide to another. As a result of dextransucrase reactions, high molecular weight dextrans are produced on fabric surfaces. In dextrans, glucose residues are linked by 1-6-α linkages. Modification of cotton fiber with carbohydrates, oligo and polysaccharides, delivers benefits such as anti-wrinkling, color maintenance, dye fixation and soil repulsion. The durability of these benefits may require covalent linkage of the oligosaccharides.

It has been found that dextransucrase can be bound to oligosaccharides to cellulose polymers in cotton. As a result of this binding via the transfer reactions catalyzed by the dextransucrase provided improved fabric appearance benefits i.e., improved anti-wrinkling, shape retention, anti-shrinkage, dye fixation, soil repulsion and tensile strength benefits. When the reaction products are bound (may or may not be a covalent linkage) to cotton, they modify the cotton surface and fibrils, which in turn delivers the fabric care benefits discussed above. Dextransucrase with sucrose also provided improved whiteness benefits (dyes from other color garments are not deposited on white fabrics). The dextransucrase/sucrose combination forms high molecular weight dextran (and smaller oligomers when other saccharides such as maltose, cellobiose, etc., are present).

Furthermore, it has been found that the deposition efficiency of reaction products on the fabrics is high, and that the reaction products are all not washed off in the following wash cycle.

The glucansucrases can be incorporated into heavy duty liquid detergents, heavy duty granular detergents, fabric care compositions, and the like.

In addition to their usefulness in laundry detergent and fabric care compositions, glucansucrases can also be used in solutions for the treatment of fabrics in the textile process industry, and for the treatment of paper and paper pulp.

When glucansucrase is present in the compositions of the present invention, it is desirable that the substrate (typically sucrose or other disaccharides) concentration in the compositions is in the range of from about 0.01% to 30% by weight of the total composition, more preferably, 1% to 10% by weight of the total composition. Furthermore, the compositions of the present invention can have smaller polysaccharides such as sucrose, maltose, maltdextrins, cellosaccharides, and types of starch added to the compositions to obtain the benefits discussed above.

These transferases are preferably incorporated into the compositions in accordance with the invention at a level of from 0.0001% to 10%, more preferably from 0.0005% to 5%, most preferred from 0.001% to 1% pure enzyme by weight of the total composition.

The fabric care and/or cleaning benefits can be obtained by the laundry and/or fabric care compositions of the present invention in presence or absence of the corresponding natural substrate. In general, the first part of the enzyme name indicates the substrate for the enzyme reaction and the second part is the acceptor to which the group is transferred. The substrate of the transferase enzyme can be the fabric itself, stains and/or soils, added in any treatment including pre- or post-treatment from the textile industry and/or from any washing and/or fabric care process, and/or added together with the transferase-containing composition.

Examples of substrates for some of the transferases listed above are: S-adenosyl-L-methionine, 5,1 0-methylenetetrahydrofolate or formiminotetra-hydrofolate (hydroxymethyl or formyl group transfer to glycine), formaldehyde, acetyl Co A, methyl-a,w-diamine, palmityl Co A, geranoyl di phosphate.

In particular, the substrate for the aminoacyl transferases is an amino containing compound such as an amino acid, a di/tri/polypeptide and/or a protein.

Among the glycosyltransferases, though the transferring group is a glycosyl residue, the specifics of the substrate for each enzyme is derived from the first part of the name. Especially for the glycosyltransferases, the natural substrate could be any alpha-glucosyl saccharide chosen from amylaceous substances in a dimer, oligomer and/or polymer. The examples are preferably different forms of starch (gelatinized, liquefied, solubilized), partial starch hydrolysate, more preferably malto-oligosaccharides, and most preferably maltose. Of interest are also substituted starch/sugar substrates, containing methylation and carboxylation substitution. Alternatively, the following substrates could be used for the mentioned glycosyltransferases: dextrins, sucrose, raffinose, fructosyl polymers, UDP glucose, xyloglucan, GDP glucose, arylamine, UDP galacturonate, ADP glucose, indole-3-acetate, a-D-glucans, UDP-xylan.

The transferase-substrates are preferably incorporated into the compositions in accordance with the invention at a level of from 0.01% to 30%, more preferably from 0.1% to 20%, most preferably from 1% to 10% by weight of the total composition.

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Nowadays, it is common practice to modify wild-type enzymes via protein/genetic engineering techniques in order to optimise their performance efficiency in the cleaning compositions of the invention. For example, the variants may be designed such that the compatibility of the enzyme to commonly encountered ingredients of such compositions is increased. Alternatively, the variant may be designed such that the optimal pH, bleach and/or chelant stability, catalytic activity and the like, of the enzyme variant is tailored to suit the particular fabric conditioning and/or cleaning application.

In particular, attention should be focused on amino acids sensitive to oxidation in the case of bleach stability and on surface charges for the surfactant compatibility. The isoelectric point of such enzymes may be modified by the substitution of some charged amino acids, e.g. an increase in isoelectric point may help to improve compatibility with anionic surfactants. The stability of the enzymes may be further enhanced by the creation of e.g. additional salt bridges and enforcing calcium binding sites to increase chelant stability.

Surfactants

Preferably, the detergent compositions according to the present invention comprise a surfactant or surfactant system wherein the surfactant can be selected from nonionic and/or anionic and/or cationic and/or ampholytic and/or zwitterionic and/or semi-polar nonionic surfactants.

The surfactant is typically present at a level of from 0.1% to 60% by weight. More preferred levels of incorporation are 1% to 35% by weight, most preferably from 1% to 30% by weight of detergent compositions in accord with the invention.

The surfactant is preferably formulated to be compatible with enzyme components present in the composition. In liquid or gel compositions the surfactant is most preferably formulated such that it promotes, or at least does not degrade, the stability of any enzyme in these compositions.

Examples of suitable nonionic, anionic, cationic, ampholytic, zwitterionic and semi-polar nonionic surfactants are disclosed in U.S. Pat. Nos. 5,707,950 and 5,576,282.

Highly preferred nonionic surfactants are polyhydroxy fatty acid amide surfactants of the formula:

R²—C(O)—N(R¹)—Z,

wherein R¹ is H, or R¹ is C₁₋₄ hydrocarbyl, 2-hydroxy ethyl, 2-hydroxy propyl or a mixture thereof, R² is C₅₋₃₁ hydrocarbyl, and Z is a polyhydroxyhydrocarbyl having a linear hydrocarbyl chain with at least 3 hydroxyls directly connected to the chain, or an alkoxylated derivative thereof. Preferably, R₁ is methyl, R² is a straight C₁₁₋₁₅ alkyl or C₁₆₋₁₈ alkyl or alkenyl chain such as coconut alkyl or mixtures thereof, and Z is derived from a reducing sugar such as glucose, fructose, maltose, lactose, in a reductive amination reaction.

Highly preferred anionic surfactants include alkyl alkoxylated sulfate surfactants hereof are water soluble salts or acids of the formula RO(A)ₘSO3M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein.

When included therein, the laundry detergent compositions of the present invention typically comprise from about 1% to about 40%, preferably from about 3% to about 20% by weight of such anionic surfactants.

Highly preferred cationic surfactants are the water-soluble quaternary ammonium compounds useful in the present composition having the formula:

R₁R₂R₃R₄N⁺X⁻

wherein R₁ is C₈-C₁₆ alkyl, each of R₂, R₃ and R₄ is independently C₁-C₄ alkyl, C₁-C₄ hydroxy alkyl, benzyl, and —(C₂H₄₀)ₓH where x has a value from 2 to 5, and X is an anion. Not more than one of R₂, R₃ or R₄ should be benzyl.

When included therein, the detergent compositions of the present invention typically comprise from 0.2% to about 25%, preferably from about 1% to about 8% by weight of such cationic surfactants.

When included therein, the detergent compositions of the present invention typically comprise from 0.2% to about 15%, preferably from about 1% to about 10% by weight of such ampholytic surfactants.

When included therein, the detergent compositions of the present invention typically comprise from 0.2% to about 15%, preferably from about 1% to about 10% by weight of such zwitterionic surfactants.

When included therein, the detergent compositions of the present invention typically comprise from 0.2% to about 15%, preferably from about 1% to about 10% by weight of such semi-polar nonionic surfactants.

The detergent composition of the present invention may further comprise a cosurfactant selected from the group of primary or tertiary amines.

Suitable primary amines for use herein include amines according to the formula R₁NH₂ wherein R₁ is a C₆-C₁₂, preferably C₆-C₁₀ alkyl chain or R₄X(CH₂)ₙ, X is —O—, —C(O)NH— or —NH—, R₄ is a C₆-C₁₂ alkyl chain n is between 1 to 5, preferably 3. R₁ alkyl chains may be straight or branched and may be interrupted with up to 12, preferably less than 5 ethylene oxide moieties.

Preferred amines according to the formula herein above are n-alkyl amines. Suitable amines for use herein may be selected from 1-hexylamine, 1-octylamine, 1-decylamine and laurylamine. Other preferred primary amines include C8-C10 oxypropylamine, octyloxypropylamine, 2-ethylhexyl-oxypropylamine, lauryl amido propylamine and amido propylamine.

Suitable tertiary amines for use herein include tertiary amines having the formula R₁R₂R₃N wherein R1 and R2 are C₁-C₈ alkylchains or

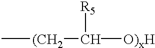

R₃ is either a C₆-C₁₂, preferably C₆-C₁₀ alkyl chain, or R₃ is R₄X(CH₂)ₙ, whereby X is —O—, —C(O)NH— or —NH—,R₄ is a C₄-C₁₂, n is between 1 to 5, preferably 2-3. R₅ is H or C₁-C₂ alkyl and x is between 1 to 6.

R₃ and R₄ may be linear or branched ; R₃ alkyl chains may be interrupted with up to 12, preferably less than 5, ethylene oxide moieties.

Preferred tertiary amines are R₁R₂R₃N where R1 is a C6-C12 alkyl chain, R2 and R3 are C1-C3 alkyl or

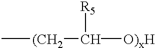

where R5 is H or CH3 and x=1-2.

Also preferred are the amidoamines of the formula:

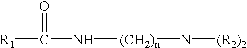

wherein R₁ is C₆-C₁₂ alkyl; n is 2-4,

preferably n is 3; R₂ and R₃ is C₁-C₄

Most preferred amines of the present invention include 1-octylamine, 1-hexylamine, 1-decylamine, 1-dodecylamine,C8-looxypropylamine, N coco 1-3diaminopropane, coconutalkyldimethylamine, lauryldimethylamine, lauryl bis(hydroxyethyl)amine, coco bis(hydroxyehtyl)amine, lauryl amine 2 moles propoxylated, octyl amine 2 moles propoxylated, lauryl amidopropyldimethylamine, C8-10 amidopropyldimethylamine and C10 amidopropyldimethylamine.

The most preferred amines for use in the compositions herein are 1-hexylamine, 1-octylamine, 1-decylamine, 1-dodecylamine. Especially desirable are n-dodecyldimethylamine and bishydroxyethylcoconutalkylamine and oleylamine 7 times ethoxylated, lauryl amido propylamine and cocoamido propylamine.

The surfactant and surfactant system of the present invention is preferably formulated to be compatible with enzyme components present in the composition. In liquid or gel compositions the surfactant is most preferably formulated such that it promotes, or at least does not degrade, the stability of any enzyme in these compositions.

Builders

The compositions according to the present invention may further comprise a builder or builder system. Any conventional builder system is suitable for use herein including aluminosilicate materials, silicates, polycarboxylates, alkyl- or alkenyl-succinic acid and fatty acids, materials such as ethylenediamine tetraacetate, diethylene triamine pentamethyleneacetate, metal ion sequestrants such as aminopolyphosphonates, particularly ethylenediamine tetramethylene phosphonic acid and diethylene triamine pentamethylenephosphonic acid. Phosphate builders can also be used herein.

The present invention may include a suitable builder or detergency salt. The level of detergent salt/builder can vary widely depending upon the end use of the composition and its desired physical form. When present, the compositions will typically comprise at least about 1% builder and more typically from about 10% to about 80%, even more typically from about 15% to about 50% by weight, of the builder. Lower or higher levels, however, are not meant to be excluded.

Inorganic or P-containing detergent salts include, but are not limited to, the alkali metal, ammonium and alkanolammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulphates, and aluminosilicates. However, non-phosphate salts are required in some locales. Importantly, the compositions herein function surprisingly well even in the presence of the so-called “weak” builders (as compared with phosphates) such as citrate, or in the so-called “underbuilt” situation that may occur with zeolite or layered silicate builders.

Organic detergent builders suitable for the purposes of the present invention include, but are not restricted to, a wide variety of polycarboxylate compounds. As used herein, “polycarboxylate” refers to compounds having a plurality of carboxylate groups, preferably at least 3 carboxylates. Polycarboxylate builder can generally be added to the composition in acid form, but can also be added in the form of a neutralized salt. When utilized in salt form, alkali metals, such as sodium, potassium, and lithium, or alkanolammonium salts are preferred.

Examples of suitable silicate builders, carbonate salts, aluminosilicate builders, polycarboxylate builders, citrate builders, 3,3-dicarboxy-4-oxa-1,6-hexanedioate builders and related compounds disclosed in U.S. Pat. No. 4,566,984, to Bush, succinic acid builders, phosphorous-based builders and fatty acids, are disclosed in U.S. Pat. Nos. 5,576,282, 5,728,671 and 5,707,950.

Additional suitable builders can be an inorganic ion exchange material, commonly an inorganic hydrated aluminosilicate material, more particularly a hydrated synthetic zeolite such as hydrated zeolite A, X, B, HS or MAP.

Specific polycarboxylates suitable for the present invention are polycarboxylates containing one carboxy group include lactic acid, glycolic acid and ether derivatives thereof as disclosed in Belgian Patent Nos. 831,368, 821,369 and 821,370. Polycarboxylates containing two carboxy groups include the water-soluble salts of succinic acid, malonic acid, (ethylenedioxy) diacetic acid, maleic acid, diglycollic acid, tartaric acid, tartronic acid and fumaric acid, as well as the ether carboxylates described in German Offenlegenschrift 2,446,686, and 2,446,687 and U.S. Pat. No. 3,935,257 and the sulfinyl carboxylates described in Belgian Patent No. 840,623. Polycarboxylates containing three carboxy groups include, in particular, water-soluble citrates, aconitrates and citraconates as well as succinate derivatives such as the carboxymethyloxysuccinates described in British Patent No. 1,379,241, lactoxysuccinates described in Netherlands Application 7205873, and the oxypolycarboxylate materials such as 2-oxa-1,1,3-propane tricarboxylates described in British Patent No. 1,387,447.

Polycarboxylates containing four carboxy groups include oxydisuccinates disclosed in British Patent No. 1,261,829, 1,1,2,2-ethane tetracarboxylates, 1,1,3,3-5 propane tetracarboxylates and 1,1,2,3-propane tetracarboxylates. Polycarboxylates containing sulfo substituents include the sulfosuccinate derivatives disclosed in British Patent Nos. 1,398,421 and 1,398,422 and in U.S. Pat. No. 3,936,448, and the sulfonated pyrolysed citrates described in British Patent No. 1,082,179, while polycarboxylates containing phosphone substituents are disclosed in British Patent No. 1,439,000.

Alicyclic and heterocyclic polycarboxylates include cyclopentane-cis,cis,cis-tetracarboxylates, cyclopentadienide pentacarboxylates, 2,3,4,5-tetrahydro-furan-cis, cis, cis-tetracarboxylates, 2,5-tetrahydro-furan-cis-dicarboxylates, 2,2,5,5-tetrahydrofuran-tetracarboxylates, 1,2,3,4,5,6-hexane -hexacar-boxylates and carboxymethyl derivatives of polyhydric alcohols such as sorbitol, mannitol and xylitol. Aromatic poly-carboxylates include mellitic acid, pyromellitic acid and the phthalic acid derivatives disclosed in British Patent No. 1,425,343.

Of the above, the preferred polycarboxylates are hydroxycarboxylates containing up to three carboxy groups per molecule, more particularly citrates.

Preferred builder systems for use in the present compositions include a mixture of a water-insoluble aluminosilicate builder such as zeolite A or of a layered silicate (SKS-6), and a water-soluble carboxylate chelating agent such as citric acid.

Preferred builder systems include a mixture of a water-insoluble aluminosilicate builder such as zeolite A, and a watersoluble carboxylate chelating agent such as citric acid. Preferred builder systems for use in liquid detergent compositions of the present invention are soaps and polycarboxylates.

Other suitable water-soluble organic salts are the homo- or co-polymeric acids or their salts, in which the polycarboxylic acid comprises at least two carboxyl radicals separated from each other by not more than two carbon atoms. Polymers of this type are disclosed in GB-A-1,596,756. Examples of such salts are polyacrylates of MW 2000-5000 and their copolymers with maleic anhydride, such copolymers having a molecular weight of from 20,000 to 70,000, especially about 40,000.

Detergency builder salts are normally included in amounts of from 5% to 80% by weight of the composition preferably from 10% to 70% and most usually from 30% to 60% by weight.

Bleaching Agent

Additional optional detergent ingredients that can be included in the detergent compositions of the present invention include bleaching agents such as hydrogen peroxide, PB1, PB4 and percarbonate with a particle size of 400-800 microns. These bleaching agent components can include one or more oxygen bleaching agents and, depending upon the bleaching agent chosen, one or more bleach activators. When present oxygen bleaching compounds will typically be present at levels of from about 1% to about 25%.

The bleaching agent component for use herein can be any of the bleaching agents useful for detergent compositions including oxygen bleaches as well as others known in the art. The bleaching agent suitable for the present invention can be an activated or non-activated bleaching agent.

Examples of suitable bleaching agents are disclosed in U.S. Pat. Nos. 5,707,950 and 5,576,282.

The hydrogen peroxide releasing agents can be used in combination with, for example, the bleach activators disclosed in U.S. Pat. No. 5,707,950 or Phenolsulfonate ester of N-nonanoyl-6-aminocaproic acid (NACA-OBS, described in WO94/28106), which are perhydrolyzed to form a peracid as the active bleaching species, leading to improved bleaching effect. Also suitable activators are acylated citrate esters.

Useful bleaching agents, including peroxyacids and bleaching systems comprising bleach activators and peroxygen bleaching compounds for use in detergent compositions according to the invention are described in WO95/27772, WO95/27773, WO95/27774, WO95/27775 and U.S. Pat. No. 5,707,950.

Metal-containing catalysts for use in bleach compositions, include cobalt-containing catalysts such as Pentaamine acetate cobalt(III) salts and manganese-containing catalysts such as those described in EPA 549 271; EPA 549 272; EPA 458 397; U.S. Pat. No. 5,246,621; EPA 458 398; U.S. Pat. No. 5,194,416 and U.S. Pat. No. 5,114,611. Bleaching composition comprising a peroxy compound, a manganese-containing bleach catalyst and a chelating agent is described in the patent application No 94870206.3.

Dye Transfer Inhibition

The detergent compositions of the present invention can also include compounds for inhibiting dye transfer from one fabric to another of solubilized and suspended dyes encountered during fabric laundering and conditioning operations involving colored fabrics.

Polymeric Eye Transfer Inhibiting Agents

The detergent compositions according to the present invention can also comprise from 0.001% to 10%, preferably from 0.01% to 2%, more preferably from 0.05% to 1% by weight of polymeric dye transfer inhibiting agents. Said polymeric dye transfer inhibiting agents are normally incorporated into detergent compositions in order to inhibit the transfer of dyes from colored fabrics onto fabrics washed therewith. These polymers have the ability to complex or adsorb the fugitive dyes washed out of dyed fabrics before the dyes have the opportunity to become attached to other articles in the wash.

Especially suitable polymeric dye transfer inhibiting agents are polyamine N-oxide polymers, copolymers of N-vinylpyrrolidone and N-vinylimidazole, polyvinylpyrrolidone polymers, polyvinyloxazolidones and polyvinylimidazoles or mixtures thereof. Examples of such dye transfer inhibiting agents are disclosed in U.S. Pat. Nos. 5,707,950 and 5,707,951.

Additional suitable dye transfer inhibiting agents include, but are not limited to, cross-linked polymers. Cross-linked polymers are polymers whose backbone are interconnected to a certain degree; these links can be of chemical or physical nature, possibly with active groups n the backbone or on branches; cross-linked polymers have been described in the Journal of Polymer Science, volume 22, pages 1035-1039.

In one embodiment, the cross-linked polymers are made in such a way that they form a three-dimensional rigid structure, which can entrap dyes in the pores formed by the three-dimensional structure. In another embodiment, the cross-linked polymers entrap the dyes by swelling.

Such cross-linked polymers are described in the co-pending European patent application 94870213.9.

Addition of such polymers also enhances the performance of the enzymes according the invention.

Dispersants

The detergent composition of the present invention can also contain dispersants. Suitable water-soluble organic salts are the homo- or co-polymeric acids or their salts, in which the polycarboxylic acid comprises at least two carboxyl radicals separated from each other by not more than two carbon atoms.

Polymers of this type are disclosed in GB-A-1,596,756. Examples of such salts are polyacrylates of MW 2000-5000 and their copolymers with maleic anhydride, such copolymers having a molecular weight of from 1,000 to 100,000.

Especially, copolymer of acrylate and methylacrylate such as the 480N having a molecular weight of 4000, at a level from 0.5-20% by weight of composition can be added in the detergentcompositions of the present invention.

The compositions of the invention may contain a lime soap peptiser compound, which has a lime soap dispersing power (LSDP), as defined hereinafter of no more than 8, preferably no more than 7, most preferably no more than 6. The lime soap peptiser compound is preferably present at a level from 0% to 20% by weight.

A numerical measure of the effectiveness of a lime soap peptiser is given by the lime soap dispersant power (LSDP) which is determined using the lime soap dispersant test as described in an article by H. C. Borghetty and C. A. Bergman, J. Am. Oil. Chem. Soc., volume 27, pages 88-90, (1950). This lime soap dispersion test method is widely used by practitioners in this art field being referred to, for example, in the following review articles; W. N. Linfield, Surfactant science Series, Volume 7, page 3; W. N. Linfield, Tenside surf. det., volume 27, pages 159-163, (1990); and M. K. Nagarajan, W. F. Masler, Cosmetics and Toiletries, volume 104, pages 71-73, (1989). The LSDP is the % weight ratio of dispersing agent to sodium oleate required to disperse the lime soap deposits formed by 0.025g of sodium oleate in 30 ml of water of 333 ppm CaCo₃ (Ca:Mg=3:2) equivalent hardness.

Surfactants having good lime soap peptiser capability will include certain amine oxides, betaines, sulfobetaines, alkyl ethoxysulfates and ethoxylated alcohols.

Exemplary surfactants having a LSDP of no more than 8 for use in accord with the present invention include C₁₆-C₁₈ dimethyl amine oxide, C₁₂-C₁₈ alkyl ethoxysulfates with an average degree of ethoxylation of from 1-5, particularly C₁₂-C₁₅ alkyl ethoxysulfate surfactant with a degree of ethoxylation of amount 3 (LSDP=4), and the C₁₄-C₁₅ ethoxylated alcohols with an average degree of ethoxylation of either 12 (LSDP=6) or 30, sold under the tradenames Lutensol A012 and Lutensol A030 respectively, by BASF GmbH.

Polymeric lime soap peptisers suitable for use herein are described in the article by M. K. Nagarajan, W. F. Masler, to be found in Cosmetics and Toiletries, volume 104, pages 71-73, (1989).

Hydrophobic bleaches such as 4-[N-octanoyl-6-aminohexanoyl]benzene sulfonate, 4-[N-nonanoyl-6-aminohexanoyl]benzene sulfonate, 4-[N-decanoyl-6-aminohexanoyl]benzene sulfonate and mixtures thereof; and nonanoyloxy benzene sulfonate together with hydrophilic/hydrophobic bleach formulations can also be used as lime soap peptisers compounds.

Examples of other suitable dispersing agents are disclosed in U.S. Pat. Nos. 5,576,282 and 5,728,671.

Conventional Detergent Enzymes

It has also been surprisingly found that the combination of a transferase with a detergent enzyme—especially a protease, cellulase, lipase and/or amylase—provides, refurbishes or restores improved tensile strength, enhanced anti-wrinkle, anti-shrinkage, anti-bobbling properties to fabrics, as well as provide better static control, fabric softness, colour appearance and fabric anti-wear properties and benefits. In addition, improved cleaning benefits are achieved with said combinations.

Said enzymes include enzymes selected from hemicellulases, cellulase, peroxidases, gluco-amylases, amylases, xylanases, lipases, phospholipases, esterases, cutinases, pectinases, keratinases, reductases, oxidases, phenoloxidases, lipoxygenases, ligninases, pullulanases, tannases, pentosanases, malanases, 13-gilucanases, arabinosidases, hyaluronidase, chondroitinase, laccase or mixtures thereof.

A preferred combination is a laundry detergent and/or fabric care composition having cocktail of conventional applicable enzymes like protease, amylase, lipase, cutinase and/or cellulase in conjunction with one or more plant cell wall degrading enzymes.

Examples of suitable enzymes are disclosed in U.S. Pat. Nos. 5,576,282, 5,728,671 and 5,707,950.

A preferred combination is a detergent composition having cocktail of conventional applicable enzymes like protease, lipase, cutinase and/or cellulase in conjunction with the hexosaminidase.

Particularly useful proteases are described in PCT publications: WO 95/30010 published Nov. 9, 1995 by The Procter & Gamble Company; WO 95/30011 published Nov. 9, 1995 by The Procter & Gamble Company; and WO 95/29979 published Nov. 9, 1995 by The Procter & Gamble Company.

In addition to the peroxidase enzymes disclosed in U.S. Pat. Nos. 5,576,282, 5,728,671 and 5,707,950, other suitable peroxidase enzymes are disclosed in European Patent application EP No. 96870013.8, filed Feb. 20, 1996. Also suitable is the laccase enzyme.

Preferred enhancers are substituted phenthiazine and phenoxasine 10-Phenothiazinepropionicacid (PPT), 10-ethylphenothiazine-4-carboxylic acid (EPC), 10-phenoxazinepropionic acid (POP) and 10-methylphenoxazine (described in WO 94/12621) and substitued syringates (C3-C5 substitued alkyl syringates) and phenols. Sodium percarbonate or perborate are preferred sources of hydrogen peroxide.

Said peroxidases are normally incorporated in the detergent composition at levels from 0.0001% to 2% of active enzyme by weight of the detergent composition.

Other preferred enzymes that can be included in the detergent compositions of the present invention include lipases. Suitable lipase enzymes for detergent usage include those produced by microorganisms of the Pseudomonas group, such as Pseudomonas stutzeri ATCC 19.154, as disclosed in British Patent 1,372,034. Suitable lipases include those which show a positive immunological cross-reaction with the antibody of the lipase, produced by the microorganism Pseudomonas fluorescent IAM 1057. This lipase is available from Amano Pharmaceutical Co. Ltd., Nagoya, Japan, under the trade name Lipase P “Amano,” hereinafter referred to as “Amano-P”. Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. Especially suitable lipases are lipases such as M1 Lipase^{R and} Lipomax^{R} (Gist-Brocades) and Lipolase^{R} and Lipolase Ultra^{R}(Novo) which have found to be very effective when used in combination with the compositions of the present invention.

Also suitable are cutinases [EC 3.1.1.50] which can be considered as a special kind of lipase, namely lipases which do not require interfacial activation. Addition of cutinases to detergent compositions have been described in e.g. WO 88/09367 (Genencor).

The lipases and/or cutinases are normally incorporated in the detergent composition at levels from 0.0001% to 2% of active enzyme by weight of the detergent composition.

Known amylases (α and/or β) can be included for removal of carbohydrate-based stains. WO 94/02597, Novo Nordisk A/S published Feb. 3, 1994, describes cleaning compositions which incorporate mutant amylases. See also WO94/18314, Genencor, published Aug. 18, 1994 and WO95/10603, Novo Nordisk A/S, published Apr. 20, 1995. Other amylases known for use in detergent compositions include both α- and β-amylases. α-Amylases are known in the art and include those disclosed in U.S. Pat. No. 5,003,257; EP 252,666; WO 91/00353; FR 2,676,456; EP 285,123; EP 525,610; EP 368,341; and British Patent Specification No. 1,296,839 (Novo). Other suitable amylase are stability-enhanced amylases including Purafact Ox Am^{R} described in WO 94/18314, published Aug. 18, 1994 and WO96/05295, Genencor, published Feb. 22, 1996 and amylase variants from Novo Nordisk A/S, disclosed in WO 95/10603, published April 95.

Examples of commercial α-amylases products are TERMAMYL®, BAN®, FUNGAMYL® and DURAMYL®, all available from Novo Nordisk A/S Denmark. WO95/26397 describes other suitable amylases: α-amylases characterised by having a specific activity at least 25% higher than the specific activity of TERMAMYL® at a temperature range of 25° C. to 55° C. and at a pH value in the range of 8 to 10, measured by the PHADEBAS® α-amylase activity assay. Other amylolytic enzymes with improved properties with respect to the activity level and the combination of thermostability and a higher activity level are described in WO95/35382.

The above-mentioned enzymes may be of any suitable origin, such as vegetable, animal, bacterial, fungal and yeast origin. Purified or non-purified forms of these enzymes may be used. Also included by definition, are mutants of native enzymes. Mutants can be obtained e.g. by protein and/or genetic engineering, chemical and/or physical modifications of native enzymes. Common practice as well is the expression of the enzyme via host organisms in which the genetic material responsible for the production of the enzyme has been cloned.

Said enzymes are normally incorporated in the detergent composition at levels from 0.0001% to 2% of active enzyme by weight of the detergent composition. The enzymes can be added as separate single ingredients (prills, granulates, stabilized liquids, etc. containing one enzyme) or as mixtures of two or more enzymes (e.g. cogranulates).

Other suitable detergent ingredients that can be added are enzyme oxidation scavengers. Examples of such enzyme oxidation scavengers are ethoxylated tetraethylene polyamines.

A range of enzyme materials and means for their incorporation into synthetic detergent compositions is also disclosed in WO 9307263 and WO 9307260 to Genencor International, WO 8908694 to Novo, and U.S. Pat. No. 3,553,139, Jan. 5, 1971 to McCarty et al. Enzymes are further disclosed in U.S. Pat. No. 4,101,457, Place et al, Jul. 18, 1978, and in U.S. Pat. No. 4,507,219, Hughes, Mar. 26, 1985. Enzyme materials useful for liquid detergent formulations, and their incorporation into such formulations, are disclosed in U.S. Pat. No. 4,261,868, Hora et al, Apr. 14, 1981. Enzymes for use in detergents can be stabilized by various techniques. Enzyme stabilisation techniques are disclosed and exemplified in U.S. Pat. No. 3,600,319, Aug. 17, 1971, Gedge et al, EP 199,405 and EP 200,586, Oct. 29, 1986, Venegas. Enzyme stabilisation systems are also described, for example, in U.S. Pat. No. 3,519,570. A useful Bacillus, sp. AC13 giving proteases, xylanases and cellulases, is described in WO 9401532 to Novo.

Chelating Agents

The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Examples of suitable chelating agents are disclosed in U.S. Pat. No. 5,728,671.

The compositions herein may also contain water-soluble methyl glycine diacetic acid (MGDA) salts (or acid form) as a chelant or co-builder useful with, for example, insoluble builders such as zeolites, layered silicates and the like.

If utilized, these chelating agents will generally comprise from about 0.1% to about 15% by weight of the detergent compositions herein. More preferably, if utilized, the chelating agents will comprise from about 0.1% to about 3.0% by weight of such compositions.

Suds Suppressor

Another optional ingredient is a suds suppressor, exemplified by silicones, and silica-silicone mixtures. Examples of suitable suds suppressors are disclosed in U.S. Pat. Nos. 5,707,950 and 5,728,671. These suds suppressors are normally employed at levels of from 0.001% to 2% by weight of the composition, preferably from 0.01% to 1% by weight.

Softening Agents

Fabric softening agents can also be incorporated into laundry detergent compositions in accordance with the present invention. These agents may be inorganic or organic in type. Inorganic softening agents are exemplified by the smectite clays disclosed in GB-A-1 400 898 and in U.S. Pat. No. 5,019,292. Organic fabric softening agents include the water insoluble tertiary amines as disclosed in GB-Al 514 276 and EP-BO 011 340 and their combination with mono C12-C14 quaternary ammonium salts are disclosed in EP-B-0 026 527 and EP-B-0 026 528 and di-long-chain amides as disclosed in EP-B-0 242 919. Other useful organic ingredients of fabric softening systems include high molecular weight polyethylene oxide materials as disclosed in EP-A-0 299 575 and 0 313 146.

Particularly suitable fabric softening agents are disclosed in U.S. Pat. Nos. 5,707,950 and 5,728,673.

Levels of smectite clay are normally in the range from 2% to 20%, more preferably from 5% to 15% by weight, with the material being added as a dry mixed component to the remainder of the formulation. Organic fabric softening agents such as the water-insoluble tertiary amines or dilong chain amide materials are incorporated at levels of from 0.5% to 5% by weight, normally from 1% to 3% by weight whilst the high molecular weight polyethylene oxide materials and the water soluble cationic materials are added at levels of from 0.1% to 2%, normally from 0.15% to 1.5% by weight. These materials are normally added to the spray dried portion of the composition, although in some instances it may be more convenient to add them as a dry mixed particulate, or spray them as molten liquid on to other solid components of the composition.

Typical cationic fabric softening components include the water-insoluble quatemary-ammonium fabric softening actives, the most commonly used having been di-long alkyl chain ammonium chloride or methyl sulfate. Preferred cationic softeners among these include the following:

1) ditallow dimethylammonium chloride (DTDMAC);

2) dihydrogenated tallow dimethylammonium chloride;

3) dihydrogenated tallow dimethylammonium methylsulfate;

4) distearyl dimethylammonium chloride;

5) dioleyl dimethylammonium chloride;

6) dipalmityl hydroxyethyl methylammonium chloride;

7) stearyl benzyl dimethylammonium chloride;

8) tallow trimethylammonium chloride;

9) hydrogenated tallow trimethylammonium chloride;

10) C₁₂₋₁₄ alkyl hydroxyethyl dimethylammonium chloride;

11) C₁₂₋₁₈ alkyl dihydroxyethyl methylammonium chloride;

12) di(stearoyloxyethyl) dimethylammonium chloride (DSOEDMAC);

13) di(tallowoyloxyethyl) dimethylammonium chloride;

14) ditallow imidazolinium methylsulfate;

15) 1-(2-tallowylamidoethyl)-2-tallowyl imidazolinium methylsulfate.

Biodegradable quaternary ammonium compounds have been presented as alternatives to the traditionally used di-long alkyl chain ammonium chlorides and methyl sulfates. Such quaternary ammonium compounds contain long chain alk(en)yl groups interrupted by functional groups such as carboxy groups. Said materials and fabric softening compositions containing them are disclosed in numerous publications such as EP-A-0,040,562, and EP-A-0,239,910.

Non-limiting examples of softener-compatible anions for the quaternary ammonium compounds and amine precursors include chloride or methyl sulfate.

Preservatives

The laundry detergent and/or fabric care compositions herein may also optionally contain one or more preservatives. The function of the preservatives is to prevent organisms/micro-organisms from breeding and growing on the fabrics treated with the laundry detergent and/or fabric care compositions herein. In the absence of such preservatives, organisms/micro-organisms could grow on the fabrics treated with the laundry detergent and/or fabric care compositions herein because a significant amount of carbohydrates/sugar could remain on the fabrics after treatment.

Sanitization of fabrics can be achieved by the compositions of the present invention containing antimicrobial materials, e.g., antibacterial halogenated compounds, quaternary compounds, and phenolic compounds.

Suitable preservatives for use with the present invention include, but are not limited to, the following.

It is preferable to use a broad spectrum preservative, e.g., one that is effective on both bacteria (both gram positive and gram negative) and fungi. A limited spectrum preservative, e.g., one that is only effective on a single group of microorganisms, e.g., fungi, can be used in combination with a broad spectrum preservative or other limited spectrum preservatives with complimentary and/or supplementary activity. A mixture of broad spectrum preservatives can also be used. In some cases where a specific group of microbial contaminants is problematic (such as Gram negatives), aminocarboxylate chelators may be used alone or as potentiators in conjunction with other preservatives. These chelators which include, e.g., ethylenediaminetetraacetic acid (EDTA), hydroxyethylenediaminetriacetic acid, diethylenetriaminepentaacetic acid, and other aminocarboxylate chelators, and mixtures thereof, and their salts, and mixtures thereof, can increase preservative effectiveness against Gram-negative bacteria, especially Pseudomonas species.

Antimicrobial preservatives useful in the present invention include biocidal compounds, i.e., substances that kill microorganisms, or biostatic compounds, i.e., substances that inhibit and/or regulate the growth of microorganisms.

(1) Organic Sulfur Compounds

Preferred water-soluble preservatives for use in the present invention are organic sulfur compounds. Some non-limiting examples of organic sulfur compounds suitable for use in the present invention are:

(a) 3-Isothiazolone Compounds

A preferred preservative is an antimicrobial, organic preservative containing 3-isothiazolone groups having the formula:

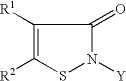

wherein Y is an unsubstituted alkyl, alkenyl, or alkynyl group of from about 1 to about 18 carbon atoms, an unsubstituted or substituted cycloalkyl group having from about a 3 to about a 6 carbon ring and up to 12 carbon atoms, an unsubstituted or substituted aralkyl group of up to about 10 carbon atoms, or an unsubstituted or substituted aryl group of up to about 10 carbon atoms; R¹ is hydrogen, halogen, or a (C₁-C₄) alkyl group; and R² is hydrogen, halogen, or a (C₁-C₄) alkyl group.

Preferably, when Y is methyl or ethyl, R¹ and R² should not both be hydrogen. Salts of these compounds formed by reacting the compound with acids such as hydrochloric, nitric, sulfuric, etc. are also suitable.

This class of compounds is disclosed in U.S. Pat. No. 4,265,899, Lewis et al., issued May 5, 1981, and incorporated herein by reference. Examples of said compounds are: 5-chloro-2-methyl-4-isothiazolin-3-one; 2-n-butyl-3-isothiazolone; 2-benzyl-3-isothiazolone; 2-phenyl-3-isothiazolone, 2-methyl-4,5-dichloroisothiazolone; ; 5-chloro-2-methyl-3-isothiazolone; 2-methyl-4-isothiazolin-3-one; and mixtures thereof. A preferred preservative is a water-soluble mixture of 5-chloro-2-methyl-4-isothiazolin-3-one and 2-methyl-4-isothiazolin-3-one, more preferably a mixture of about 77% 5-chloro-2-methyl-4-isothiazolin-3-one and about 23% 2-methyl-4-isothiazolin-3-one, a broad spectrum preservative available as a 1.5% aqueous solution under the trade name Kathon® CG by Rohm and Haas Company.

When Kathon® is used as the preservative in the present invention it is present at a level of from about 0.0001% to about 0.01%, preferably from about 0.0002% to about 0.005%, more preferably from about 0.0003% to about 0.003%, most preferably from about 0.0004% to about 0.002%, by weight of the composition.

Other isothiazolins include 1,2-benzisothiazolin-3-one, available under the trade name Proxel® products; and 2-methyl-4,5-trimethylene-4-isothiazolin-3-one, available under the trade name Promexal®. Both Proxel and Promexal are available from Zeneca. They have stability over a wide pH range (i.e., 4-12). Neither contain active halogen and are not formaldehyde releasing preservatives. Both Proxel and Promexal are effective against typical Gram negative and positive bacteria, fungi and yeasts when used at a level from about 0.001% to about 0.5%, preferably from about 0.005% to about 0.05%, and most preferably from about 0.01% to about 0.02% by weight of the usage composition.

(b) Sodium Pyrithione

Another preferred organic sulfur preservative is sodium pyrithione, with water solubility of about 50%. When sodium pyrithione is used as the preservative in the present invention it is typically present at a level of from about 0.0001% to about 0.01%, preferably from about 0.0002% to about 0.005%, more preferably from about 0.0003% to about 0.003%, by weight of the usage composition.

Mixtures of the preferred organic sulfur compounds can also be used as the preservative in the present invention.

(2) Halogenated Compounds

Preferred preservatives for use in the present invention are halogenated compounds. Some non-limiting examples of halogenated compounds suitable for use in the present invention are:

(a) 5-bromo-5-nitro-1,3-dioxane, available under the trade name Bronidox L® from Henkel. Bronidox L® has a solubility of about 0.46% in water. When Bronidox is used as the preservative in the present invention it is typically present at a level of from about 0.0005% to about 0.02%, preferably from about 0.001% to about 0.01%, by weight of the usage composition;

(b) 2-bromo-2-nitropropane-1,3-diol, available under the trade name Bronopol® from Inolex can be used as the preservative in the present invention. Bronopol has a solubility of about 25% in water. When Bronopol is used as the preservative in the present invention it is typically present at a level of from about 0.002% to about 0.1%, preferably from about 0.005% to about 0.05%, by weight of the usage composition;

(c) 1,1′-hexamethylene bis(5-(p-chlorophenyl)biguanide), commonly known as chlorhexidine, and its salts, e.g., with acetic and gluconic acids can be used as a preservative in the present invention. The digluconate salt is highly water-soluble, about 70% in water, and the diacetate salt has a solubility of about 1.8% in water. When chlorohexidine is used as the preservative in the present invention it is typically present at a level of from about 0.0001% to about 0.04%, preferably from about 0.0005% to about 0.01%, by weight of the usage composition.

(d) 1,1,1-Trichloro-2-methylpropan-2-ol, commonly known as chlorobutanol, with water solubility of about 0.8%; a typical effective level of chlorobutanol is from about 0.1% to about 0.5%, by weight of the usage composition;

(e) 4,4′- (Trimethylenedioxy)bis-(3-bromobenzamidine) diisethionate, or dibromopropamidine, with water solubility of about 50%; when dibromopropamidine is used as the preservative in the present invention it is typically present at a level of from about 0.0001% to about 0.05%, preferably from about 0.0005% to about 0.01% by weight of the usage composition.

Mixtures of the preferred halogenated compounds can also be used as the preservative in the present invention.

(3) Cyclic Organic Nitrogen Compounds

Preferred water-soluble preservatives for use in the present invention are cyclic organic nitrogen compounds. Some non-limiting examples of cyclic organic nitrogen compounds suitable for use in the present invention are:

(a) Imidazolidinedione Compounds

Preferred preservatives for use in the present invention are imidazolidione compounds. Some non-limiting examples of imidazolidinedione compounds suitable for use in the present invention are:

1,3-bis(hydroxymethyl)-5,5-dimethyl-2,4-imidazolidinedione, commonly known as dimethyloldimethylhydantoin, or DMDM hydantoin, available as, e.g., Glydant ® from Lonza. DMDM hydantoin has a water solubility of more than 50% in water, and is mainly effective on bacteria. When DMDM hydantoin is used, it is preferable that it be used in combination with a broad spectrum preservative such as Kathon CG®, or formaldehyde. A preferred mixture is about a 95:5 DMDM hydantoin to 3-butyl-2-iodopropynylcarbamate mixture, available under the trade name Glydant Plus® from Lonza. When Glydant Plus® is used as the preservative in the present invention, it is typically present at a level of from about 0.005% to about 0.2% by weight of the usage composition;

N-[1,3-bis(hydroxymethyl)2,5-dioxo-4-imidazolidinyl]-N,N′-bis(hydroxymethyl) urea, commonly known as diazolidinyl urea, available under the trade name Germall II® from Sutton Laboratories, Inc. (Sutton) can be used as the preservative in the present invention. When Germall II® is used as the preservative in the present invention, it is typically present at a level of from about 0.01% to about 0.1% by weight of the usage composition;

N,N″-methylenebis {N′-[1-(hydroxymethyl)-2,5-dioxo-4-imidazolidinyl]urea}, commonly known as imidazolidinyl urea, available, e.g., under the trade name Abiol® from 3V-Sigma, Unicide U-13® from Induchem, Germall 115® from (Suffon) can be used as the preservative in the present invention. When imidazolidinyl urea is used as the preservative, it is typically present at a level of from about 0.05% to about 0.2%, by weight of the usage composition.

Mixtures of the preferred imidazolidinedione compounds can also be used as the preservative in the present invention.

(b) Polymethoxy Bicyclic Oxazolidine

Another preferred water-soluble cyclic organic nitrogen preservative is polymethoxy bicyclic oxazolidine, having the general formula:

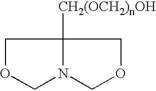

where n has a value of from about 0 to about 5, and is available under the trade name Nuosept® C from Hüls America. When Nuosept® C is used as the preservative, it is typically present at a level of from about 0.005% to about 0.1%, by weight of the usage composition.

Mixtures of the preferred cyclic organic nitrogen compounds can also be used as the preservative in the present invention.

(4) Low Molecular Weight Aldehydes

(a) Formaldehyde

A preferred preservative for use in the present invention is formaldehyde. Formaldehyde is a broad spectrum preservative which is normally available as formalin which is a 37% aqueous solution of formaldehyde. When formaldehyde is used as the preservative in the present invention, typical levels are from about 0.003% to about 0.2%, preferably from about 0.008% to about 0.1%. more preferably from about 0.01% to about 0.05%, by weight of the usage composition.

(b) Glutaraldehyde

A preferred preservative for use in the present invention is glutaraldehyde. Glutaraldehyde is a water-soluble, broad spectrum preservative commonly available as a 25% or a 50% solution in water. When glutaraldehyde is used as the preservative in the present invention it is typically present at a level of from about 0.005% to about 0.1%, preferably from about 0.01% to about 0.05%, by weight of the usage composition.

(5) Quaternary Compounds

Preferred preservatives for use in the present invention are cationic and/or quaternary compounds. Such compounds include polyaminopropyl biguanide, also known as polyhexamethylene biguanide having the general formula:

HCl.NH₂—(CH₂)₃—[—(CH₂)₃—NH—C(═NH)—NH—C(═NH.HCl)—NH—(CH₂)3—]ₓ—(CH₂)₃—NH—C(═NH)—NH.CN

Polyaminopropyl biguanide is a water-soluble, broad spectrum preservative which is available as a 20% aqueous solution available under the trade name Cosmocil CQ® from ICI Americas, Inc., or under the trade name Mikrokill® from Brooks, Inc.

1-(3-Chlorallyl) -3,5,7-triaza-1-azoniaadamantane chloride, available, e.g., under the trade name Dowicil 200 from Dow Chemical, is an effective quaternary ammonium preservative; it is freely soluble in water; however, it has the tendency to discolor (yellow), therefore it is not highly preferred.

Mixtures of the preferred quaternary ammonium compounds can also be used as the preservative in the present invention.

When quaternary ammonium compounds are used as the preservative in the present invention, they are typically present at a level of from about 0.005% to about 0.2%, preferably from about 0.01% to about 0.1%, by weight of the usage composition.

(6). Dehydroacetic Acid

A preferred preservative for use in the present invention is dehydroacetic acid. Dehydroacetic acid is a broad spectrum preservative preferably in the form of a sodium or a potassium salt so that it is water-soluble. This preservative acts more as a biostatic preservative than a biocidal preservative. When dehydroacetic acid is used as the preservative it is typically used at a level of from about 0.005% to about 0.2%, preferably from about 0.008% to about 0.1%, more preferably from about 0.01% to about 0.05%, by weight of the usage composition.

(7) Phenyl and Phenolic Compounds

Some non-limiting examples of phenyl and phenolic compounds suitable for use in the present invention are:

4,4′-diamidino-α,ω-diphenoxypropane diisethionate, commonly known as propamidine isethionate, with water solubility of about 16%; and 4,4′-diamidino-α,ω-diphenoxyhexane diisethionate, commonly known as hexamidine isethionate. Typical effective level of these salts is about 0.0002% to about 0.05% by weight of the usage composition.

Other examples are benzyl alcohol, with a water solubility of about 4%; 2-phenylethanol, with a water solubility of about 2%; and 2-phenoxyethanol, with a water solubility of about 2.67%; typical effective level of these phenyl and phenoxy alcohol is from about 0.1% to about 0.5%, by weight of the usage composition.

(8) Mixtures Thereof

It is preferred that no, or essentially no, volatile low molecular weight monohydric alcohols such as ethanol and/or isopropanol are intentionally added to the composition of the present invention since these volatile organic compounds will contribute both to flammability problems and environmental pollution problems. If small amounts of low molecular weight monohydric alcohols are present in the composition of the present invention due to the addition of these alcohols to such things as perfumes and as stabilizers for some preservatives, it is preferable that the level of monohydric alcohol be less than about 5%, preferably less than about 3%, more preferably less than about 1%.

(9) Mixtures Thereof

The preservatives of the present invention can be used in mixtures in order to control a broad range of microorganisms.

Bacteriostatic effects can sometimes be obtained for aqueous compositions by adjusting the composition pH to an acid pH, e.g., less than about pH 4, preferably less than about pH 3, or a basic pH, e.g., greater than about 10, preferably greater than about 11.

(10) Preferred Preservatives

Preferably the preservatives used in the compositions of the present invention are selected from the group consisting of: isothiazolones; Bronopol; hydantoins; oxazolidines; glutaraldehyde; isethionates; quats (benzalkoniums); and mixtures thereof.

Other Detergent Components

The laundry detergent and/or fabric care compositions of the invention may also contain additional detergent and/or fabric care components. The precise nature of these additional components, and levels of incorporation thereof will depend on the physical form of the composition, and the nature of the cleaning operation for which it is to be used.

Examples of other components used in detergent compositions include, but are not limited to, soil-suspending agents, soil-release agents, optical brighteners, abrasives, bactericides, tarnish inhibitors, coloring agents, and/or encapsulated or non-encapsulated perfumes, examples of which are disclosed in U.S. Pat. Nos. 5,707,950, 5,576,282 and 5,728,671.

It is well known in the art that free chlorine in tap water rapidly deactivates the enzymes comprised in detergent compositions. Therefore, using chlorine scavenger such as perborate, ammonium sulfate, sodium sulphite or polyethyleneimine at a level above 0.1% by weight of total composition, in the formulas will provide improved through the wash stability of the detergent enzymes. Compositions comprising chlorine scavenger are described in the European patent application 92870018.6 filed Jan. 31, 1992.

Alkoxylated polycarboxylates such as those prepared from polyacrylates are useful herein to provide additional grease removal performance. Such materials are described in WO 91/08281 and PCT 90/01815 at p. 4 et seq., incorporated herein by reference. Chemically, these materials comprise polyacrylates having one ethoxy side-chain per every 7-8 acrylate units. The side-chains are of the formula —(CH₂CH₂O)ₘ(CH₂)ₙCH₃ wherein m is 2-3 and n is 6-12. The side-chains are ester-linked to the polyacrylate “backbone” to provide a “comb” polymer type structure. The molecular weight can vary, but is typically in the range of about 2000 to about 50,000. Such alkoxylated polycarboxylates can comprise from about 0.05% to about 10%, by weight, of the compositions herein.

Detergent Composition Form

The laundry detergent and/or fabric care compositions according to the invention can be liquid, paste, gels, bars, tablets, spray, foam, powder or granular forms. Granular compositions can also be in “compact” form, the liquid compositions can also be in a “concentrated” form.

The compositions of the invention may for example, be formulated as hand and machine laundry detergent compositions including laundry additive compositions and compositions suitable for use in the soaking and/or pre-treatment of stained fabrics, rinse added fabric softener compositions. Pre-or post treatment of fabric include gel, spray and liquid fabric care compositions. A rinse cycle with or without the presence of softening agents is also contemplated. When formulated as compositions suitable for use in a laundry machine washing method, the compositions of the invention preferably contain both a surfactant and a builder compound and additionally one or more detergent components preferably selected from organic polymeric compounds, bleaching agents, additional enzymes, suds suppressors, dispersants, lime-soap dispersants, soil suspension and anti-redeposition agents and corrosion inhibitors. Laundry compositions can also contain softening agents, as additional detergent components.

The compositions of the invention can also be used as detergent additive products. Such additive products are intended to supplement or boost the performance of conventional detergent compositions.

If needed the density of the laundry detergent compositions herein ranges from 400 to 1200 g/liter, preferably 600 to 950 g/liter of composition measured at 20° C.

The “compact” form of the compositions herein is best reflected by density and, in terms of composition, by the amount of inorganic filler salt; inorganic filler salts are conventional ingredients of detergent compositions in powder form; in conventional detergent compositions, the filler salts are present in substantial amounts, typically 17-35% by weight of the total composition.

In the compact compositions, the filler salt is present in amounts not exceeding 15% of the total composition, preferably not exceeding 10%, most preferably not exceeding 5% by weight of the composition.

The inorganic filler salts, such as meant in the present compositions are selected from the alkali and alkaline-earth-metal salts of sulphates and chlorides.

A preferred filler salt is sodium sulphate.

Liquid detergent compositions according to the present invention can also be in a “concentrated form”, in such case, the liquid detergent compositions according the present invention will contain a lower amount of water, compared to conventional liquid detergents.

Typically the water content of the concentrated liquid detergent is preferably less than 40%, more preferably less than 30%, most preferably less than 20% by weight of the detergent composition.

The compositions of the present invention can be incorporated into a spray dispenser that can create an article of manufacture that can facilitate the cleaning and/or fabric care of fabric. Compositions containing from 1 ppm to 50 ppm of pure transferase enzyme by weight of total composition and 0.01% to 20% of its corresponding substrate by weight of total composition, are preferably sprayed onto the fabrics and therefore typically packaged in a spray dispenser.

The spray dispenser can be any of the manually activated means for producing a spray of liquid droplets as is known in the art, e.g. trigger-type, pump-type, non-aerosol self-pressurized, and aerosol-type spray means. It is preferred that at least about 70%, more preferably, at least about 80%, most preferably at least about 90% of the droplets have a particle size of smaller than about 200 microns.

The spray dispenser can be an aerosol dispenser. Said aerosol dispenser comprises a container which can be constructed of any of the conventional materials employed in fabricating aerosol containers. The dispenser must be capable of withstanding internal pressure in the range of from about 20 to about 110 p.s.i.g., more preferably from about 20 to about 70 p.s.i.g. The one important requirement concerning the dispenser is that it be provided with a valve member which will permit the wrinkle reducing composition contained in the dispenser to be dispensed in the form of a spray of very fine, or finely divided, particles or droplets. The aerosol dispenser utilizes a pressurized sealed container from which the wrinkle reducing composition is dispensed through a special actuator/valve assembly under pressure. The aerosol dispenser is pressurized by incorporating therein a gaseous component generally known as a propellant. Common aerosol propellants, e.g., gaseous hydrocarbons such as isobutane, and mixed halogenated hydrocarbons, are not preferred. Halogenated hydrocarbon propellants such as chlorofluoro hydrocarbons have been alleged to contribute to environmental problems. Preferred propellants are compressed air, nitrogen, inert gases, carbon dioxide, etc. A more complete description of commercially available aerosol spray dispensers appears in U.S. Pat. Nos. 3,436,772, Stebbins, issued Apr. 8, 1969; and 3,600,325, Kaufman et al., issued Aug. 17, 1971; both of said references are incorporated herein by reference.

Preferably the spray dispenser can be a self-pressurized non-aerosol container having a convoluted liner and an elastomeric sleeve. Said self-pressurized dispenser comprises a liner/sleeve assembly containing a thin, flexible radially expandable convoluted plastic liner of from about 0.010 to about 0.020 inch thick, inside an essentially cylindrical elastomeric sleeve. The liner/sleeve is capable of holding a substantial quantity of odor-absorbing fluid product and of causing said product to be dispensed. A more complete description of self-pressurized spray dispensers can be found in U.S. Pat. Nos. 5,111,971, Winer, issued May 12, 1992; and 5,232,126, Winer, issued Aug. 3, 1993; both of said references are herein incorporated by reference. Another type of aerosol spray dispenser is one wherein a barrier separates the wrinkle reducing composition from the propellant (preferably compressed air or nitrogen), as is disclosed in U.S. Pat. No. 4,260,110, issued Apr. 7, 1981, incorporated herein by reference. Such a dispenser is available from EP Spray Systems, East Hanover, N.J.

More preferably, the spray dispenser is a non-aerosol, manually activated, pump-spray dispenser. Said pump-spray dispenser comprises a container and a pump mechanism which securely screws or snaps onto the container. The container comprises a vessel for containing the wrinkle reducing composition to be dispensed.

The pump mechanism comprises a pump chamber of substantially fixed, volume, having an opening at the inner end thereof. Within the pump chamber is located a pump stem having a piston on the end thereof disposed for reciprocal motion in the pump chamber. The pump stem has a passageway there through with a dispensing outlet at the outer end of the passageway and an axial inlet port located inwardly thereof.

The container and the pump mechanism can be constructed of any conventional material employed in fabricating pump-spray dispensers, including, but not limited to: polyethylene; polypropylene, polyethlyleneterephthalate; blends of polyethylene, vinyl acetate, and rubber elastomer. Other materials can include stainless steel. A more complete disclosure of commercially available dispensing devices appears in: U.S. Pat. Nos. 4,895,279, Schultz, issued Jan. 23, 1990; 4,735,347, Schultz et al., issued Apr. 5, 1988; and 4,274,560, Carter, issued Jun. 23, 1981; all of said references are herein incorporated by reference.

Most preferably, the spray dispenser is a manually activated trigger-spray dispenser. Said trigger-spray dispenser comprises a container and a trigger both of which can be constructed of any of the conventional material employed in fabricating trigger-spray dispensers, including, but not limited to : polyethylene, polypropylene, polyacetal, polycarbonate, polyethylene-terephthalate , polyvinyl chloride, polystyrene, blends of polyethylene, vinyl acetate, and rubber elastomer. Other materials can include stainless steel and glass. The trigger-spray dispenser does not incorporate a propellant gas. The trigger-spray dispenser herein is typically one which acts upon a discrete amount of the wrinkle reducing composition itself, typically by means of a piston or a collapsing bellows that displaces the composition through a nozzle to create a spray of thin liquid. Said trigger-spray dispenser typically comprises a pump chamber having either a piston or bellows which is movable through a limited stroke response to the trigger for varying the volume of said pump chamber. This pump chamber or bellows chamber collects and holds the product for dispensing. The trigger spray dispenser typically has an outlet check valve for blocking communication and flow of fluid through the nozzle and is responsive to the pressure inside the chamber. For the piston type trigger sprayers, as the trigger is compressed, it acts on the fluid in the chamber and the spring, increasing the pressure on the fluid. For the bellows spray dispenser, as the bellows is compressed, the pressure increases on the fluid. The increase in fluid pressure in either trigger-spray dispenser acts to open the top outlet check valve. The top valve allows the product to be forced through the swirl chamber and out the nozzle to form a discharge pattern. An adjustable nozzle cap can be used to vary the pattern of the fluid dispensed.

For the piston spray dispenser, as the trigger is released, the spring acts on the piston to return to its original position. For the bellows spray dispenser, the bellows acts as the spring to return to its original position. This action causes a vacuum in the chamber. The responding fluid acts to close the outlet valve while opening the inlet valve drawing product up the chamber from the reservoir.

A more complete disclosure of commercially available dispensing devices appears in U.S. Pat. Nos. 4,082,223, Nozawa, issued Apr. 4, 1978; 4,161,288, McKinney, issued Jul. 7, 1985; 4,434,917, Saito et al., issued Mar. 6, 1984; and 4,819,835, Tasaki, issued Apr. 11, 1989; 5,303,867, Peterson, issued Apr. 19, 1994; all of said references are incorporated herein by reference.

A broad array of trigger sprayers or finger pump sprayers are suitable for use with the compositions of this invention. These are readily available from suppliers such as Calmar, Inc., City of Industry, California; CSI (Continental Sprayers, Inc.), St. Peters, Missouri; Berry Plastics Corp., Evansville, Ind.—a distributor of Guala ® sprayers; or Seaquest Dispensing, Cary, Ill.

The preferred trigger sprayers are the blue inserted Guala® sprayer, available from Berry Plastics Corp., the Calmar TS800-1A® sprayers, available from Calmar Inc., or the CSI T7500® available from Continental Sprayers Inc., because of the fine uniform spray characteristics, spray volume and pattern size. Any suitable bottle or container can be used with the trigger sprayer, the preferred bottle is a 17 fl-oz. bottle (about 500 ml) of good ergonomics similar in shape to the Cinch® bottle. It can be made of any materials such as high density polyethylene, polypropylene, polyvinyl chloride, polystyrene, polyethylene terephthalate, glass or any other material that forms bottles. Preferably, it is made of high density polyethylene or polyethylene terephthalate.

For smaller four fl-oz size (about 118 ml), a finger pump can be used with canister or cylindrical bottle. The preferred pump for this application is the cylindrical Euromist II® from Seaquest Dispensing.

Methods of Washing and/or Fabric Care

The compositions of the invention may be used in essentially any washing, cleaning and/or fabric care methods, including soaking methods, spray-on treatment methods, pre-treatment methods, methods with rinsing steps for which a separate rinse aid composition may be added, post-treatment methods and drying methods wherein the composition may be added during the drying cycle, especially when an automatic dryer is used.

In another aspect of the invention, there is also provided a method for providing, refurbishing or restoring tensile strength, anti-wrinkle, anti-bobbling and anti-shrinkage -properties to fabrics, as well as providing static control, fabric softness, colour appearance and fabric anti-wear properties and cleaning benefits on treated fabrics upon domestic treatment which comprises the step of contacting the fabric with a composition comprising a transferase enzyme. The contacting step may occur in an aqueous medium such as in a rinse cycle, soaking, pre- or post-treatment processes or in an non-aqueous medium such as occurs during a tumble-drying process in the presence or absence of the corresponding natural substrate. The substrate of the transferase enzyme can be the fabric itself, stains and/or soils, added in any treatment including pre- or post-treatment from the textile industry and/or from any washing and/or fabric care process, and/or added together with the transferase-containing composition.

The process of the invention is conveniently carried out in the course of the cleaning process. The method of cleaning is preferably carried out at 5° C. to 95° C., especially between 10° C. and 60° C. The pH of the treatment solution is preferably from 7 to 12.

The following examples are meant to exemplify compositions of the present invention, but are not necessarily meant to limit or otherwise define the scope of the invention.

In the detergent compositions, the enzymes levels are expressed by pure enzyme by weight of the total composition and unless otherwise specified, the detergent ingredients are expressed by weight of the total compositions. The abbreviated component identifications therein have the following meanings:

| | |
|---|---|
| LAS | Sodium linear C₁₂ alkyl benzene sulphonate |
| TAS | Sodium tallow alkyl sulphate |
| CXYAS | Sodium C_{1X}-C_{1Y} alkyl sulfate |
| 25EY | A C₁₂-C₁₅ predominantly linear primary alcohol |
| | condensed with an average of Y moles of ethylene oxide |
| CXYEZ | A C_{1X}-C_{1Y} predominantly linear primary alcohol |
| | condensed with an average of Z moles of ethylene oxide |
| XYEZS | C_{1X}-C_{1Y} sodium alkyl sulfate condensed with an average |
| | of Z moles of ethylene oxide per mole |
| QAS | R₂.N⁺(CH₃)₂(C₂H₄OH) with R₂ = C₁₂-C₁₄ |
| Soap | Sodium linear alkyl carboxylate derived from a 80/20 |
| | mixture of tallow and coconut oils. |
| Nonionic | C₁₃-C₁₅ mixed ethoxylated/propoxylated fatty alcohol |
| | with an average degree of ethoxylation of 3.8 and an |
| | average degree of propoxylation of 4.5 sold under the |
| | tradename Plurafac LF404 by BASF Gmbh. |
| CFAA | C₁₂-C₁₄ alkyl N-methyl glucamide |
| TFAA | C₁₆-C₁₈ alkyl N-methyl glucamide. |
| TPKFA | C12-C14 topped whole cut fatty acids. |
| DEQA | Di-(tallow-oxy-ethyl) dimethyl ammonium chloride. |
| DEQA (1) | Di-(oleyloxyethyl) dimethyl ammonium methylsulfate. |
| DEQA (2) | Di-(soft-tallowyloxyethyl) hydroxyethyl methyl |
| | ammonium methylsulfate. |
| DTDMAMS | Ditallow dimethyl ammonium methylsulfate. |
| Glycoperse | Polyethoxylated sorbitan monostearate available form |
| S-20 | Lonza. |
| Clay | Calcium bentonite clay, Bentonite L, available from |
| | Southern Clay Products. |
| SDASA | 1:2 ratio of stearyldimethyl amine:triple-pressed stearic |
| | acid. |
| Neodol 45-13 | C14-C15 linear primary alcohol ethoxylate, sold by Shell |
| | Chemical CO. |
| Silicate | Amorphous Sodium Silicate (SiO₂:Na₂O ratio = 2.0) |
| NaSKS-6 | Crystalline layered silicate of formula δ-Na₂Si₂O_{5.} |
| Carbonate | Anhydrous sodium carbonate with a particle size between |
| | 200 μm and 900 μm. |
| Bicarbonate | Anhydrous sodium bicarbonate with a particle size |
| | between 400 μm and 1200 μm. |
| STPP | Anhydrous sodium tripolyphosphate |
| MA/AA | Copolymer of 1:4 maleic/acrylic acid, average molecular |
| | weight about 70,000-80,000 |
| Zeolite A | Hydrated Sodium Aluminosilicate of formula |
| | Na₁₂(AlO₂SiO₂)₁₂.27H₂O having a primary particle size |
| | in the range from 0.1 to 10 micrometers |
| Citrate | Tri-sodium citrate dihydrate of activity 86.4% with a |
| | particle size distribution between 425 μm and 850 μm. |
| Citric | Anhydrous citric acid |
| PB1 | Anhydrous sodium perborate monohydrate bleach, |
| | empirical formula NaBO₂.H₂O₂ |
| PB4 | Anhydrous sodium perborate tetrahydrate |
| Percarbonate | Anhydrous sodium percarbonate bleach of empirical |
| | formula 2Na₂CO₃.3H₂O₂ |
| TAED | Tetraacetyl ethylene diamine. |
| NOBS | Nonanoyloxybenzene sulfonate in the form of the sodium |
| | salt. |
| Photoactivated | Sulfonated zinc phtalocyanine encapsulated in dextrin |
| Bleach | soluble polymer. |
| Transferase | Transferase EC 2.4.1.24 sold by Genencor under the |
| | tradename Transglucosidase L-500 and Transferase |
| | EC 2.3.2.13 available from Novo Nordisk under the |
| | name transglutaminase. |
| Substrate | Maltose, e.g. Maltose M5885 sold by Sigma and/or |
| | Starch, e.g. YES2760 sold by Sigma or an amino acid, |
| | di/tri/poly peptide and/or protein. |
| Protease | Proteolytic enzyme sold under the tradename Savinase, |
| | Alcalase, Durazym by Novo Nordisk A/S, Maxacal, |
| | Maxapem sold by Gist-Brocades and proteases described |
| | in patents WO91/06637 and/or WO95/10591 and/or |
| | EP 251 446. |
| Amylase | Amylolytic enzyme sold under the tradename Purafact |
| | Ox Am^{R} described in WO94/18314, WO96/05295 sold |
| | by Genencor; Termamyl ®, Fungamyl ® and |
| | Duramyl ®, all available from Novo Nordisk A/S and |
| | those described in WO95/26397. |
| Lipase | Lipolytic enzyme sold under the tradename Lipolase, |
| | Lipolase Ultra by Novo Nordisk A/S or Lipomax by |
| | Gist-Brocades. |
| Cellulase | Cellulytic enzyme sold under the tradename Carezyme, |
| | Celluzyme and/or Endolase by Novo Nordisk A/S. |
| CMC | Sodium carboxymethyl cellulose. |
| HEDP | 1,1-hydroxyethane diphosphonic acid. |
| DETPMP | Diethylene triamine penta (methylene phosphonic acid), |
| | marketed by Monsanto under the Trade name Dequest |
| | 2060. |
| PVNO | Poly(4-vinylpyridine)-N-Oxide. |
| PVPVI | Poly (4-vinylpyridine)-N-oxide/copolymer of vinyl- |
| | imidazole and vinyl-pyrrolidone. |
| Brightener 1 | Disodium 4,4′-bis(2-sulphostyryl)biphenyl. |
| Brightener 2 | Disodium 4,4′-bis(4-anilino-6-morpholino-1.3.5-triazin- |
| | 2-yl) stilbene-2:2′-disulfonate. |
| Silicone | Polydimethylsiloxane foam controller with siloxane- |
| antifoam | oxyalkylene copolymer as dispersing agent with a ratio of |
| | said foam controller to said dispersing agent of 10:1 to |
| | 100:1. |
| Granular Suds | 12% Silicone/silica, 18% stearyl alcohol, 70% starch in |
| Suppressor | granular form |
| SRP 1 | Sulfobenzoyl or sodium isethionate end capped esters |
| | with oxyethylene oxy and terephtaloyl backbone. |
| SRP 2 | Diethoxylated poly (1,2 propylene terephtalate) short |
| | block polymer. |
| Sulphate | Anhydrous sodium sulphate. |
| HMWPEO | High molecular weight polyethylene oxide |
| Encapsulated | Insoluble fragrance delivery technology utilising zeolite |
| perfume | 13x, perfume and a dextrose/glycerin agglomerating |
| particles | binder. |

### EXAMPLE 1

The following laundry detergent compositions were prepared in accordance with the invention:

| | I | II | III | IV | V | VI |
|---|---|---|---|---|---|---|
| LAS | 8.0 | 8.0 | 8.0 | 8.0 | 8.0 | 8.0 |
| C25E3 | 3.4 | 3.4 | 3.4 | 3.4 | 3.4 | 3.4 |
| QAS | — | 0.8 | 0.8 | — | 0.8 | 0.8 |
| Zeolite A | 18.1 | 18.1 | 18.1 | 18.1 | 18.1 | 18.1 |
| Carbonate | 13.0 | 13.0 | 13.0 | 27.0 | 27.0 | 27.0 |
| Silicate | 1.4 | 1.4 | 1.4 | 3.0 | 3.0 | 3.0 |
| Sulfate | 26.1 | 26.1 | 26.1 | 26.1 | 16.1 | 16.1 |
| PB4 | 9.0 | 9.0 | 9.0 | 9.0 | 9.0 | 9.0 |
| TAED | 1.5 | 1.5 | 1.5 | 1.5 | 1.5 | 1.5 |
| DETPMP | 0.25 | 0.25 | 0.25 | 0.25 | 0.25 | 0.25 |
| HEDP | 0.3 | 0.3 | 0.3 | 0.3 | 0.3 | 0.3 |
| Transferase | 1.0 | 0.1 | 0.05 | 0.02 | 0.1 | 0.5 |
| Substrate | 0.1 | — | 5.0 | — | 10.0 | 15.0 |
| Protease | 0.0026 | 0.0026 | 0.0026 | 0.0026 | 0.0026 | 0.0026 |
| Amylase | — | 0.0009 | 0.0009 | 0.0009 | 0.0009 | 0.0009 |
| MA/AA | 0.3 | 0.3 | 0.3 | 0.3 | 0.3 | 0.3 |
| CMC | 0.2 | 0.2 | 0.2 | 0.2 | 0.2 | 0.2 |
| Photoactivated | 15 | 15 | 15 | 15 | 15 | 15 |
| bleach (ppm) | | | | | | |
| Brightener 1 | 0.09 | 0.09 | 0.09 | 0.09 | 0.09 | 0.09 |
| Perfume | 0.3 | 0.3 | 0.3 | 0.3 | 0.3 | 0.3 |
| Silicone | 0.5 | 0.5 | 0.5 | 0.5 | 0.5 | 0.5 |
| antifoam | | | | | | |
| Misc/minors | | | | | | |
| to 100% | | | | | | |
| Density in | 850 | 850 | 850 | 850 | 850 | 850 |
| g/litre | | | | | | |

### EXAMPLE 2

The following granular laundry detergent compositions of bulk density 750 g/liter were prepared in accord with the invention:

| | I | II | III | IV | V |
|---|---|---|---|---|---|
| LAS | 5.25 | 5.25 | 5.6 | 4.8 | 4.8 |
| TAS | 1.25 | 1.25 | 1.9 | 1.6 | 1.6 |
| C45AS | — | — | 2.2 | 3.9 | 3.9 |
| C25AE3S | — | — | 0.8 | 1.2 | 1.2 |
| C45E7 | 3.25 | 3.25 | — | 5.0 | 5.0 |
| C25E3 | — | — | 5.5 | — | — |
| QAS | 0.8 | 0.8 | 2.0 | 2.0 | 2.0 |
| STPP | 19.7 | 19.7 | — | — | — |
| Zeolite A | — | — | 19.5 | 19.5 | 19.5 |
| NaSKS-6/citric acid | — | — | 10.6 | 10.6 | 10.6 |
| (79:21) | | | | | |
| Carbonate | 6.1 | 6.1 | 21.4 | 21.4 | 21.4 |
| Bicarbonate | — | — | 2.0 | 2.0 | 2.0 |
| Silicate | 6.8 | 6.8 | — | — | — |
| Sodium sulfate | 39.8 | 39.8 | — | 4.3 | 4.3 |
| PB4 | 5.0 | 5.0 | 12.7 | — | — |
| TAED | 0.5 | 0.5 | 3.1 | — | — |
| DETPMP | 0.25 | 0.25 | 0.2 | 0.2 | 0.2 |
| HEDP | — | — | 0.3 | 0.3 | 0.3 |
| Transferase | 0.02 | 1.5 | 0.1 | 0.5 | 0.0008 |
| Substrate | — | 0.1 | 5.0 | 10.0 | 12.0 |
| Protease | 0.0026 | 0.0026 | 0.0085 | 0.045 | 0.045 |
| Lipase | 0.003 | 0.003 | 0.003 | 0.003 | 0.003 |
| Cellulase | 0.0006 | 0.0006 | 0.0006 | 0.0006 | 0.0006 |
| Amylase | 0.0009 | 0.0009 | 0.0009 | 0.0009 | 0.0009 |
| MA/AA | 0.8 | 0.8 | 1.6 | 1.6 | 1.6 |
| CMC | 0.2 | 0.2 | 0.4 | 0.4 | 0.4 |
| Photoactivated bleach | 15 ppm | 15 ppm | 27 ppm | 27 ppm | 27 ppm |
| (ppm) | | | | | |
| Brightener 1 | 0.08 | 0.08 | 0.19 | 0.19 | 0.19 |
| Brightener 2 | — | — | 0.04 | 0.04 | 0.04 |
| Encapsulated perfume | 0.3 | 0.3 | 0.3 | 0.3 | 0.3 |
| particles | | | | | |
| Silicone antifoam | 0.5 | 0.5 | 2.4 | 2.4 | 2.4 |
| Minors/misc to 100% | | | | | |

### EXAMPLE 3

The following detergent formulations, according to the present invention were prepared, where I is a phosphorus-containing detergent composition, II is a zeolite-containing detergent composition and III is a compact detergent composition:

| | I | II | III | IV | V |
|---|---|---|---|---|---|
| Blown Powder | | | | | |
| STPP | 24.0 | 24.0 | — | 24.0 | 24.0 |
| Zeolite A | — | 24.0 | — | — | — |
| C45AS | 9.0 | 9.0 | 6.0 | 13.0 | 13.0 |
| MA/AA | 2.0 | 2.0 | 4.0 | 2.0 | 2.0 |
| LAS | 6.0 | 6.0 | 8.0 | 11.0 | 11.0 |
| TAS | 2.0 | 2.0 | — | — | — |
| Silicate | 7.0 | 7.0 | 3.0 | 3.0 | 3.0 |
| CMC | 1.0 | 1.0 | 1.0 | 0.5 | 0.5 |
| Brightener 2 | 0.2 | 0.2 | 0.2 | 0.2 | 0.2 |
| Soap | 1.0 | 1.0 | 1.0 | 1.0 | 1.0 |
| DETPMP | 0.4 | 0.4 | 0.4 | 0.2 | 0.2 |
| Spray On | | | | | |
| C45E7 | 2.5 | 2.5 | 2.5 | 2.0 | 2.0 |
| C25E3 | 2.5 | 2.5 | 2.5 | 2.0 | 2.0 |
| Silicone antifoam | 0.3 | 0.3 | 0.3 | 0.3 | 0.3 |
| Perfume | 0.3 | 0.3 | 0.3 | 0.3 | 0.3 |
| Dry additives | | | | | |
| Carbonate | 6.0 | 6.0 | 13.0 | 15.0 | 15.0 |
| PB4 | 18.0 | 18.0 | 18.0 | 10.0 | 10.0 |
| PB1 | 4.0 | 4.0 | 4.0 | 0 | 0 |
| TAED | 3.0 | 3.0 | 3.0 | 1.0 | 1.0 |
| Photoactivated bleach | 0.02 | 0.02 | 0.02 | 0.02 | 0.02 |
| Transferase | 0.005 | 1.0 | 0.1 | 0.2 | 0.0004 |
| Substrate | — | 0.1 | 10.0 | 10.0 | 5.0 |
| Protease | 0.01 | 0.01 | 0.01 | 0.01 | 0.01 |
| Lipase | 0.009 | 0.009 | 0.009 | 0.009 | 0.009 |
| Amylase | 0.002 | 0.002 | 0.003 | 0.001 | 0.001 |
| Dry mixed sodium | 3.0 | 3.0 | 3.0 | 5.0 | 5.0 |
| sulfate | | | | | |
| Balance (Moisture & | 100.0 | 100.0 | 100.0 | 100.0 | 100.0 |
| Miscellaneous) | | | | | |
| Density (g/litre) | 630 | 630 | 670 | 670 | 670 |

### EXAMPLE 4

The following nil bleach-containing detergent formulations of particular use in the washing of colored clothing, according to the present invention were prepared:

| | I | II | III | IV |
|---|---|---|---|---|
| Blown Powder | | | | |
| Zeolite A | 15.0 | 15.0 | 15.0 | — |
| Sodium sulfate | 0.0 | 0.0 | 5.0 | — |
| LAS | 3.0 | 3.0 | 3.0 | — |
| DETPMP | 0.4 | 0.4 | 0.5 | — |
| CMC | 0.4 | 0.4 | 0.4 | — |
| MA/AA | 4.0 | 4.0 | 4.0 | — |
| Agglomerates | | | | |
| C45AS | — | — | — | 11.0 |
| LAS | 6.0 | 6.0 | 5.0 | — |
| TAS | 3.0 | 3.0 | 2.0 | — |
| Silicate | 4.0 | 4.0 | 4.0 | — |
| Zeolite A | 10.0 | 10.0 | 15.0 | 13.0 |
| CMC | — | — | — | 0.5 |
| MA/AA | — | — | — | 2.0 |
| Carbonate | 9.0 | 9.0 | 7.0 | 7.0 |
| Spray On | | | | |
| Perfume | 0.3 | 0.3 | 0.3 | 0.5 |
| C45E7 | 4.0 | 4.0 | 4.0 | 4.0 |
| C25E3 | 2.0 | 2.0 | 2.0 | 2.0 |
| Dry additives | | | | |
| MA/AA | — | — | — | 3.0 |
| NaSKS-6 | — | — | — | 12.0 |
| Citrate | 10.0 | 10.0 | — | 8.0 |
| Bicarbonate | 7.0 | 7.0 | 3.0 | 5.0 |
| Carbonate | 8.0 | 8.0 | 5.0 | 7.0 |
| PVPVI/PVNO | 0.5 | 0.5 | 0.5 | 0.5 |
| Transferase | 0.025 | 0.8 | 0.5 | 0.01 |
| Substrate | — | 0.1 | 10.0 | 5.0 |
| Protease | 0.026 | 0.026 | 0.016 | 0.047 |
| Lipase | 0.009 | 0.009 | 0.009 | 0.009 |
| Amylase | 0.005 | 0.005 | 0.005 | 0.005 |
| Cellulase | 0.006 | 0.006 | 0.006 | 0.006 |
| Silicone antifoam | 5.0 | 5.0 | 5.0 | 5.0 |
| Dry additives | | | | |
| Sodium sulfate | 0.0 | 0.0 | 9.0 | 0.0 |
| Balance (Moisture and | 100.0 | 100.0 | 100.0 | 100.0 |
| Miscellaneous) | | | | |
| Density (g/litre) | 700 | 700 | 700 | 700 |

### EXAMPLE 5

The following detergent formulations, according to the present invention were prepared:

| | I | II | III | IV | V |
|---|---|---|---|---|---|
| LAS | 20.0 | 20.0 | 14.0 | 24.0 | 22.0 |
| QAS | 0.7 | 0.7 | 1.0 | — | 0.7 |
| TFAA | — | — | 1.0 | — | — |
| C25E5/C45E7 | — | — | 2.0 | — | 0.5 |
| C45E3S | — | — | 2.5 | — | — |
| STPP | 30.0 | 30.0 | 18.0 | 30.0 | 22.0 |
| Silicate | 9.0 | 9.0 | 5.0 | 10.0 | 8.0 |
| Carbonate | 13.0 | 13.0 | 7.5 | — | 5.0 |
| Bicarbonate | — | — | 7.5 | — | — |
| DETPMP | 0.7 | 0.7 | 1.0 | — | — |
| SRP 1 | 0.3 | 0.3 | 0.2 | — | 0.1 |
| MA/AA | 2.0 | 2.0 | 1.5 | 2.0 | 1.0 |
| CMC | 0.8 | 0.8 | 0.4 | 0.4 | 0.2 |
| Transferase | 0.001 | 1.0 | 0.01 | 0.5 | 0.01 |
| Substrate | 0.1 | — | 5.0 | 20.0 | — |
| Protease | 0.008 | 0.008 | 0.01 | 0.026 | 0.026 |
| Amylase | 0.007 | 0.007 | 0.004 | — | 0.002 |
| Lipase | 0.004 | 0.004 | 0.002 | 0.004 | 0.002 |
| Cellulase | 0.0015 | 0.0015 | 0.0005 | — | — |
| Photoactivated | 70 ppm | 70 ppm | 45 ppm | — | 10 ppm |
| bleach (ppm) | | | | | |
| Brightener 1 | 0.2 | 0.2 | 0.2 | 0.08 | 0.2 |
| PB1 | 6.0 | 6.0 | 2.0 | — | — |
| NOBS | 2.0 | 2.0 | 1.0 | — | — |
| Balance (Moisture | 100 | 100 | 100 | 100 | 100 |
| and Miscellaneous) | | | | | |

### EXAMPLE 6

The following detergent formulations, according to the present invention were prepared:

| | I | II | III | IV |
|---|---|---|---|---|
| Blown Powder | | | | |
| Zeolite A | 30.0 | 22.0 | 6.0 | 6.7 |
| Na SkS-6 | — | — | — | 3.3 |
| Polycarboxylate | — | — | — | 7.1 |
| Sodium sulfate | 19.0 | 5.0 | 7.0 | — |
| MA/AA | 3.0 | 3.0 | 6.0 | — |
| LAS | 14.0 | 12.0 | 22.0 | 21.5 |
| C45AS | 8.0 | 7.0 | 7.0 | 5.5 |
| Cationic | — | — | — | 1.0 |
| Silicate | — | 1.0 | 5.0 | 11.4 |
| Soap | — | — | 2.0 | — |
| Brightener 1 | 0.2 | 0.2 | 0.2 | — |
| Carbonate | 8.0 | 16.0 | 20.0 | 10.0 |
| DETPMP | — | 0.4 | 0.4 | — |
| Spray On | | | | |
| C45E7 | 1.0 | 1.0 | 1.0 | 3.2 |
| Dry additives | | | | |
| PVPVI/PVNO | 0.5 | 0.5 | 0.5 | — |
| Transferase | 1.0 | 0.01 | 0.5 | 0.1 |
| Substrate | 0.1 | — | 10.0 | 10.0 |
| Protease | 0.052 | 0.01 | 0.01 | 0.01 |
| Lipase | 0.009 | 0.009 | 0.009 | 0.009 |
| Amylase | 0.001 | 0.001 | 0.001 | 0.001 |
| Cellulase | 0.0002 | 0.0002 | 0.0002 | 0.0002 |
| NOBS | — | 6.1 | 4.5 | 3.2 |
| PB1 | 1.0 | 5.0 | 6.0 | 3.9 |
| Sodium sulfate | — | 6.0 | — | to balance |
| Balance (Moisture and | 100 | 100 | 100 | |
| Miscellaneous) | | | | |

### EXAMPLE 7

The following high density and bleach-containing detergent formulations, according to the present invention were prepared:

| | I | II | III | IV |
|---|---|---|---|---|
| Blown Powder | | | | |
| Zeolite A | 15.0 | 15.0 | 15.0 | 15.0 |
| Sodium sulfate | 0.0 | 0.0 | 5.0 | 0.0 |
| LAS | 3.0 | 3.0 | 3.0 | 3.0 |
| QAS | — | — | 1.5 | 1.5 |
| DETPMP | 0.4 | 0.4 | 0.4 | 0.4 |
| CMC | 0.4 | 0.4 | 0.4 | 0.4 |
| MA/AA | 4.0 | 4.0 | 2.0 | 2.0 |
| Agglomerates | | | | |
| LAS | 5.0 | 5.0 | 5.0 | 5.0 |
| TAS | 2.0 | 2.0 | 2.0 | 1.0 |
| Silicate | 3.0 | 3.0 | 3.0 | 4.0 |
| Zeolite A | 8.0 | 8.0 | 8.0 | 8.0 |
| Carbonate | 8.0 | 8.0 | 8.0 | 4.0 |
| Spray On | | | | |
| Perfume | 0.3 | 0.3 | 0.3 | 0.3 |
| C45E7 | 2.0 | 2.0 | 2.0 | 2.0 |
| C25E3 | 2.0 | 2.0 | — | — |
| Dry additives | | | | |
| Citrate | 5.0 | 5.0 | — | 2.0 |
| Bicarbonate | — | — | 3.0 | — |
| Carbonate | 8.0 | 8.0 | 15.0 | 10.0 |
| TAED | 6.0 | 6.0 | 2.0 | 5.0 |
| PB1 | 14.0 | 14.0 | 7.0 | 10.0 |
| Polyethylene oxide of MW | — | — | — | 0.2 |
| 5,000,000 | | | | |
| Bentonite clay | — | — | — | 10.0 |
| Transferase | 0.001 | 1.0 | 0.01 | 0.5 |
| Substrate | — | — | 5.0 | 10.0 |
| Protease | 0.01 | 0.01 | 0.01 | 0.01 |
| Lipase | 0.009 | 0.009 | 0.009 | 0.009 |
| Amylase | 0.005 | 0.005 | 0.005 | 0.005 |
| Cellulase | 0.002 | 0.002 | 0.002 | 0.002 |
| Silicone antifoam | 5.0 | 5.0 | 5.0 | 5.0 |
| Dry additives | | | | |
| Sodium sulfate | 0.0 | 0.0 | 3.0 | 0.0 |
| Balance (Moisture and | 100.0 | 100.0 | 100.0 | 100.0 |
| Miscellaneous) | | | | |
| Density (g/litre) | 850 | 850 | 850 | 850 |

### EXAMPLE 8

The following high density detergent formulations, according to the present invention were prepared:

| | I | I | II | II |
|---|---|---|---|---|
| Agglomerate | | | | |
| C45AS | 11.0 | 11.0 | 14.0 | 14.0 |
| Zeolite A | 15.0 | 15.0 | 6.0 | 6.0 |
| Carbonate | 4.0 | 4.0 | 8.0 | 8.0 |
| MA/AA | 4.0 | 4.0 | 2.0 | 2.0 |
| CMC | 0.5 | 0.5 | 0.5 | 0.5 |
| DETPMP | 0.4 | 0.4 | 0.4 | 0.4 |
| Spray On | | | | |
| C25E5 | 5.0 | 5.0 | 5.0 | 5.0 |
| Perfume | 0.5 | 0.5 | 0.5 | 0.5 |
| Dry Adds | | | | |
| HEDP | 0.5 | 0.5 | 0.3 | 0.3 |
| SKS 6 | 13.0 | 13.0 | 10.0 | 10.0 |
| Citrate | 3.0 | 3.0 | 1.0 | 1.0 |
| TAED | 5.0 | 5.0 | 7.0 | 7.0 |
| Percarbonate | 20.0 | 20.0 | 20.0 | 20.0 |
| SRP 1 | 0.3 | 0.3 | 0.3 | 0.3 |
| Transferase | 0.025 | 0.5 | 0.1 | 0.01 |
| Substrate | 0.01 | — | 12.0 | 5.0 |
| Protease | 0.014 | 0.014 | 0.014 | 0.014 |
| Lipase | 0.009 | 0.009 | 0.009 | 0.009 |
| Cellulase | 0.001 | 0.001 | 0.001 | 0.001 |
| Amylase | 0.005 | 0.005 | 0.005 | 0.005 |
| Silicone antifoam | 5.0 | 5.0 | 5.0 | 5.0 |
| Brightener 1 | 0.2 | 0.2 | 0.2 | 0.2 |
| Brightener 2 | 0.2 | 0.2 | — | — |
| Balance (Moisture | 100 | 100 | 100 | 100 |
| and Miscellaneous) | | | | |
| Density (g/litre) | 850 | 850 | 850 | 850 |

### EXAMPLE 9

The following granular detergent formulations, according to the present invention were prepared:

| | I | II | III | IV | V |
|---|---|---|---|---|---|
| LAS | 21.0 | 25.0 | 18.0 | 18.0 | — |
| Coco C12-14 AS | — | — | — | — | 21.9 |
| AE3S | — | — | 1.5 | 1.5 | 2.3 |
| Decyl dimethyl | — | 0.4 | 0.7 | 0.7 | 0.8 |
| hydroxyethyl | | | | | |
| NH4 + Cl | | | | | |
| Nonionic | 1.2 | — | 0.9 | 0.5 | — |
| Coco C12-14 Fatty | — | — | — | — | 1.0 |
| Alcohol | | | | | |
| STPP | 44.0 | 25.0 | 22.5 | 22.5 | 22.5 |
| Zeolite A | 7.0 | 10.0 | — | — | 8.0 |
| MA/AA | — | — | 0.9 | 0.9 | — |
| SRP1 | 0.3 | 0.15 | 0.2 | 0.1 | 0.2 |
| CMC | 0.3 | 2.0 | 0.75 | 0.4 | 1.0 |
| Carbonate | 17.5 | 29.3 | 5.0 | 13.0 | 15.0 |
| Silicate | 2.0 | — | 7.6 | 7.9 | — |
| Transferase | 0.001 | 0.5 | 0.01 | 0.5 | 0.05 |
| Substrate | — | 0.05 | 5.0 | 10.0 | — |
| Protease | 0.007 | 0.007 | 0.007 | 0.007 | 0.007 |
| Amylase | — | 0.004 | 0.004 | 0.004 | 0.004 |
| Lipase | 0.003 | 0.003 | 0.003 | — | — |
| Cellulase | — | 0.001 | 0.001 | 0.001 | 0.001 |
| NOBS | — | — | — | 1.2 | 1.0 |
| PB1 | — | — | — | 2.4 | 1.2 |
| Diethylene triamine | — | — | — | 0.7 | 1.0 |
| penta acetic acid | | | | | |
| Diethylene triamine | — | — | 0.6 | — | — |
| penta methyl phosphonic | | | | | |
| acid | | | | | |
| Mg Sulfate | — | — | 0.8 | — | — |
| Photoactivated bleach | 45 ppm | 50 ppm | 15 ppm | 45 ppm | 42 ppm |
| Brightener 1 | 0.05 | — | 0.04 | 0.04 | 0.04 |
| Brightener 2 | 0.1 | 0.3 | 0.05 | 0.13 | 0.13 |

| | |
|---|---|
| Water and Minors | up to 100% |

### EXAMPLE 10

The following liquid detergent formulations, according to the present invention were prepared:

| | I | II | III | IV | V | VI | VII | VIII |
|---|---|---|---|---|---|---|---|---|
| LAS | 10.0 | 13.0 | 9.0 | — | 25.0 | — | — | — |
| C25AS | 4.0 | 1.0 | 2.0 | 10.0 | — | 13.0 | 18.0 | 15.0 |
| C25E3S | 1.0 | — | — | 3.0 | — | 2.0 | 2.0 | 4.0 |
| C25E7 | 6.0 | 8.0 | 13.0 | 2.5 | — | — | 4.0 | 4.0 |
| TFAA | — | — | — | 4.5 | — | 6.0 | 8.0 | 8.0 |
| QAS | — | — | — | — | 3.0 | 1.0 | — | — |
| TPKFA | 2.0 | — | 13.0 | 2.0 | — | 15.0 | 7.0 | 7.0 |
| Rapeseed fatty | — | — | — | 5.0 | — | — | 4.0 | 4.0 |
| acids | | | | | | | | |
| Citric | 2.0 | 3.0 | 1.0 | 1.5 | 1.0 | 1.0 | 1.0 | 1.0 |
| Dodecenyl/ | 12.0 | 10.0 | — | — | 15.0 | — | — | — |
| tetradecenyl | | | | | | | | |
| succinic acid | | | | | | | | |
| Oleic acid | 4.0 | 2.0 | 1.0 | — | 1.0 | — | — | — |
| Ethanol | 4.0 | 4.0 | 7.0 | 2.0 | 7.0 | 2.0 | 3.0 | 2.0 |
| 1,2 Propanediol | 4.0 | 4.0 | 2.0 | 7.0 | 6.0 | 8.0 | 10.0 | 13.- |
| Mono Ethanol | — | — | — | 5.0 | — | — | 9.0 | 9.0 |
| Amine | | | | | | | | |
| Tri Ethanol | — | — | 8 | — | — | — | — | — |
| Amine | | | | | | | | |
| NaOH (pH) | 8.0 | 8.0 | 7.6 | 7.7 | 8.0 | 7.5 | 8.0 | 8.2 |
| Ethoxylated | 0.5 | — | 0.5 | 0.2 | — | — | 0.4 | 0.3 |
| tetraethylene | | | | | | | | |
| pentamine | | | | | | | | |
| DETPMP | 1.0 | 1.0 | 0.5 | 1.0 | 2.0 | 1.2 | 1.0 | — |
| SRP 2 | 0.3 | — | 0.3 | 0.1 | — | — | 0.2 | 0.1 |
| PVNO | — | — | — | — | — | — | — | 0.10 |
| Transferase | .001 | 0.01 | 1.0 | 0.05 | 0.5 | 0.01 | 0.01 | 0.01 |
| Substrate | 0.1 | — | 0.01 | — | 10.0 | 5.0 | — | 5.0 |
| Protease | .005 | .005 | .004 | .003 | 0.08 | .005 | .003 | .006 |
| Lipase | — | .002 | — | .0002 | — | — | .003 | .003 |
| Amylase | .002 | .002 | .005 | .004 | .002 | .008 | .005 | .005 |
| Cellulase | — | — | — | .0001 | — | — | .0004 | .0004 |
| Boric acid | 0.1 | 0.2 | — | 2.0 | 1.0 | 1.5 | 2.5 | 2.5 |
| Na formate | — | — | 1.0 | — | — | — | — | — |
| Ca chloride | — | 0.015 | — | 0.01 | — | — | — | — |
| Bentonite clay | — | — | — | — | 4.0 | 4.0 | — | — |
| Suspending | — | — | — | — | 0.6 | 0.3 | — | — |
| clay SD3 | | | | | | | | |
| Balance | 100 | 100 | 100 | 100 | 100 | 100 | 100 | 100 |
| Moisture and | | | | | | | | |
| Miscellaneous | | | | | | | | |

### EXAMPLE 11

Granular fabric detergent compositions which provide “softening through the wash” capability were prepared in accord with the present invention:

| | I | II | III | IV |
|---|---|---|---|---|
| 45AS | — | — | 10.0 | 10.0 |
| LAS | 7.6 | 7.6 | — | — |
| 68AS | 1.3 | 1.3 | — | — |
| 45E7 | 4.0 | 4.0 | — | — |
| 25E3 | — | — | 5.0 | 5.0 |
| Coco-alkyl-dimethyl hydroxy- | 1.4 | 1.4 | 1.0 | 1.0 |
| ethyl ammonium chloride | | | | |
| Citrate | 5.0 | 5.0 | 3.0 | 3.0 |
| Na-SKS-6 | — | — | 11.0 | 11.0 |
| Zeolite A | 15.0 | 15.0 | 15.0 | 15.0 |
| MA/AA | 4.0 | 4.0 | 4.0 | 4.0 |
| DETPMP | 0.4 | 0.4 | 0.4 | 0.4 |
| PB1 | 15.0 | 15.0 | — | — |
| Percarbonate | — | — | 15.0 | 15.0 |
| TAED | 5.0 | 5.0 | 5.0 | 5.0 |
| Smectite clay | 10.0 | 10.0 | 5.0 | 5.0 |
| HMWPEO | — | — | 0.1 | 0.1 |
| Transferase | 0.001 | 0.01 | 0.8 | 0.0005 |
| Substrate | — | 5.0 | — | 5.0 |
| Protease | 0.02 | 0.02 | 0.01 | 0.01 |
| Lipase | 0.02 | 0.02 | 0.01 | 0.01 |
| Amylase | 0.03 | 0.03 | 0.005 | 0.005 |
| Cellulase | 0.001 | 0.001 | — | — |
| Silicate | 3.0 | 3.0 | 5.0 | 5.0 |
| Carbonate | 10.0 | 10.0 | 10.0 | 10.0 |
| Granular suds suppressor | 1.0 | 1.0 | 4.0 | 4.0 |
| CMC | 0.2 | 0.2 | 0.1 | 0.1 |
| Water/minors | Up to | | | |
| | 100% | | | |

### EXAMPLE 12

The following pre- or post treatment compositions were prepared in accord with the present invention:

| | I | II | III | IV |
|---|---|---|---|---|
| DEQA (2) | — | — | 20.0 | 20.0 |
| Transferase | 0.8 | 0.05 | 0.05 | 0.15 |
| Substrate | — | 10.0 | 10.0 | 5.0 |
| Cellulase | — | — | 0.001 | 0.001 |
| HCL | — | — | 0.03 | 0.03 |
| Antifoam agent | — | — | 0.01 | 0.01 |
| Blue dye | 25 ppm | 25 ppm | 25 ppm | 25 ppm |
| CaCl₂ | — | — | 0.20 | 0.20 |
| Preservatives | 0.05 | 0.05 | 0.05 | 0.05 |
| Perfume | 0.90 | 0.90 | 0.90 | 0.90 |

| | |
|---|---|
| Water/minors | Up to 100% |

### EXAMPLE 13

The following fabric softener composition was prepared in accord with the present invention:

| | I | II | III | IV |
|---|---|---|---|---|
| DEQA | 2.6 | 2.6 | 19.0 | 19.0 |
| Stearic acid of IV = 0 | 0.3 | 0.3 | — | — |
| Hydrochloride acid | 0.02 | 0.02 | 0.02 | 0.02 |
| Transferase | 0.001 | 0.5 | 0.01 | 0.1 |
| Substrate | — | 0.1 | 5.0 | 5.0 |
| Perfume | 1.0 | 1.0 | 1.0 | 1.0 |
| Silicone antifoam | 0.01 | 0.01 | 0.01 | 0.01 |
| Electrolyte | — | — | 1000 ppm | 1000 ppm |
| Dye | 10 ppm | 10 ppm | 25 ppm | 25 ppm |
| Preservative | 0.05 | 0.05 | 0.05 | 0.05 |
| Water and minors | 100% | 100% | 100% | 100% |

### EXAMPLE 14

Dryer activated color care compositions and dryer added fabric conditioner compositions were prepared in accord with the present invention:

| | I | II | III | IV | V | VI |
|---|---|---|---|---|---|---|
| DEQA (1) | 39 | — | — | 39.2 | — | — |
| DEQA (2) | — | 50 | — | — | 51.8 | — |
| DTDMAMS | — | — | 26 | — | — | — |
| SDASA | 54 | 27 | 42 | 54.4 | 40.2 | 70.0 |
| Transferase | 0.1 | 1.0 | 0.01 | 0.15 | 0.1 | 0.5 |
| Substrate | 0.1 | 0.1 | — | — | 10.0 | 10.0 |
| Neodol 45-13 | — | — | — | — | — | 13.0 |
| Ethanol | — | — | — | — | — | 1.0 |
| Glycoperse S-20 | — | 15 | — | — | 15.4 | — |
| Glycerol monostearate | — | — | 26 | — | — | — |
| Perfume | 2 | 2 | 1 | 1.6 | 1.5 | 0.75 |
| Clay | 3 | 3 | 3 | — | — | — |

### EXAMPLE 15

Spray-on compositions were prepared in accord with the present invention:

| | I | II | III | IV |
|---|---|---|---|---|
| Substrate | 10.0 | 10.0 | 1.0 | 0.1 |
| Transferase | 0.001 | 0.001 | 0.01 | 0.1 |
| Polymer (e.g. Starch) | — | — | 0.1 | — |
| AcOH | 0.032 | 0.032 | 0.032 | 0.032 |
| NaOAc | 0.031 | 0.031 | 0.031 | 0.031 |
| Antifoam agent | 0.01 | 0.01 | 0.01 | 0.01 |
| Perfume | 0.01 | 0.01 | 0.01 | 0.01 |

| | |
|---|---|
| Water/Minors | Up to 100% |

### EXAMPLE 16

Syndet bar fabric detergent compositions were prepared in accord with the present invention:

| | I | II | III | IV |
|---|---|---|---|---|
| C26 AS | 20.00 | 20.00 | 20.00 | 20.00 |
| CFAA | 5.0 | 5.0 | 5.0 | 5.0 |
| LAS (C11-13) | 10.0 | 10.0 | 10.0 | 10.0 |
| Sodium carbonate | 25.0 | 25.0 | 25.0 | 25.0 |
| Sodium pyrophosphate | 7.0 | 7.0 | 7.0 | 7.0 |
| STPP | 7.0 | 7.0 | 7.0 | 7.0 |
| Zeolite A | 5.0 | 5.0 | 5.0 | 5.0 |
| CMC | 0.2 | 0.2 | 0.2 | 0.2 |
| Polyacrylate (MW 1400) | 0.2 | 0.2 | 0.2 | 0.2 |
| Coconut monethanolamide | 5.0 | 5.0 | 5.0 | 5.0 |
| Transferase | 0.001 | 0.05 | 0.5 | 0.01 |
| Substrate | 0.1 | 5.0 | 8.0 | 5.0 |
| Amylase | 0.01 | 0.02 | 0.01 | 0.01 |
| Protease | 0.3 | — | 0.5 | 0.05 |
| Brightener, perfume | 0.2 | 0.2 | 0.2 | 0.2 |
| CaSO4 | 1.0 | 1.0 | 1.0 | 1.0 |
| MgSO4 | 1.0 | 1.0 | 1.0 | 1.0 |
| Water | 4.0 | 4.0 | 4.0 | 4.0 |
| Filler*: balance to 100% | | | | |

*Can be selected from convenient materials such as CaCO3, talc, clay (Kaolinite, Smectite), silicates, and the like.

Having described the invention in detail with reference to preferred embodiments and the examples, it will be clear to those skilled in the art that various changes and modifications may be made without departing from the scope of the invention and the invention is not to be considered limited to what is described in the specification.

What is claimed is:

1. A laundry detergent and/or fabric care composition comprising a transferase, wherein when said transferase is a xyloglucan transferase, said xyloglucan transferase exhibits greater transferase activity than hydrolytic activity.

2. A laundry detergent and/or fabric care composition according to claim 1 wherein when said transferase is a xyloglucan transferase, said xyloglucan transferase further exhibits higher reaction rates for donor substrates with higher molecular weight than for donor substrates with lower molecular weight.

3. A laundry detergent and/or fabric care composition according to claim 1 wherein said transferase is present at a level of from about 0.0001% to about 10% pure enzyme by weight of composition.

4. A laundry detergent and/or fabric care composition according to claim 3 wherein said transferase is present at a level of from about 0.0005% to about 5% pure enzyme by weight of composition.

5. A laundry detergent and/or fabric care composition according to claim 1 wherein said transferase is present at a level of from about 0.001% to about 1% pure enzyme by weight of composition.

6. A laundry detergent and/or fabric care composition according to claim 1 wherein said transferase is a glycosyltransferase (EC 2.4).

7. A laundry detergent and/or fabric care composition according to claim 6 wherein said glycosyltransferase (EC 2.4) is a transglucosidase (EC 2.4.1.24).

8. A laundry detergent and/or fabric care composition according to claim 1 wherein said transferase is a mutant glycosyltransferase.

9. A laundry detergent and/or fabric care composition according to claim 1 wherein said transferase is a mutant glycosidase.

10. A laundry detergent and/or fabric care composition according to claim 1 wherein said transferase is a cyclomaltodextrin glucanotransferase (EC 2.4.1.19).

11. A laundry detergent and/or fabric care composition according to claim 1 wherein said transferase is an endoxyloglucan transferase.

12. A laundry detergent and/or fabric care composition according to claim 1 wherein said transferase is a glucansucrase.

13. A laundry detergent and/or fabric care composition according to claim 12 wherein said glucansucrase is selected from the group consisting of dextransucrase (EC 2.4.1.5), altemansucrase and mixtures thereof.

14. A laundry detergent and/or fabric care composition according to claim 1 wherein said transferase is an acyltransferase (EC 2.3).

15. A laundry detergent and/or fabric care composition according to claim 14 wherein said acyltransferase (EC 2.3) is an aminoacyl transferase (EC 2.3.2).

16. A laundry detergent and/or fabric care composition according to claim 15 wherein said aminoacyl transferase (EC 2.3.2) is a transglutaminase (EC 2.3.2.13).

17. A laundry detergent and/or fabric care composition according to claim 1 wherein said transferase has at least 50% of its maximum activity between 10° C. and 50° C.

18. A laundry detergent and/or fabric care composition according to claim 1 further comprising a substrate.

19. A laundry detergent and/or fabric care composition according to claim 18 wherein said substrate is selected from the group consisting of glycosidic dimers, oligomers, polymers, amino acids, di/tri/poly-peptides, proteins and mixtures thereof.

20. A laundry detergent and/or fabric care composition according to claim 19 wherein said substrate is selected from the group consisting of starch, maltose and mixtures thereof.

21. A laundry detergent and/or fabric care composition according to claim 18 wherein said substrate is present at a level of from 0.01% to 30%.

22. A laundry detergent and/or fabric care composition according to claim 1 further comprising a cationic, nonionic and/or anionic surfactant.

23. A laundry detergent and/or fabric care composition according to claim 1 further comprising one or more additional components selected from the group consisting of detergent enzymes, bleaching agents, dye transfer inhibiting agents, dispersants, smectite clay, cationic surfactants comprising two long chain lengths and mixtures thereof.

24. A laundry detergent and/or fabric care composition according to claim 1 wherein said composition is in a form selected from the group consisting of laundry additive, pre-treatment, post-treatment, soaking treatment, rinsing treatment, spray-on treatment and/or drying treatment.

25. A laundry detergent and/or fabric care composition according to claim 1 wherein said composition is selected from the group consisting of granular compositions containing no more than 15% of inorganic filler salt by weight of total composition and liquid compositions containing no more than 40% of water by weight of total composition.

26. A laundry detergent and/or fabric care composition comprising a transferase, wherein when said transferase is a xyloglucan transferase, said xyloglucan transferase exhibits higher reaction rates for donor substrates with higher molecular weight than for donor substrates with lower molecular weight.

27. Method comprising the step of contacting a fabric and/or a fabric treated with a substrate with the laundry detergent and/or fabric care composition according to claim 1.

28. Use of a laundry detergent and/or fabric care composition according to claim 1 for cleaning benefits and/or fabric care.

29. Use of a laundry detergent and/or fabric care composition according to claim 1 to provide fabrics with one or more of the following enhanced properties tensile strength, anti-wrinkle, anti-bobbling, anti-shrinkage, static control, fabric softness, colour appearance and/or fabric anti-wear properties.
